(19) United States
(12) Patent Application Publication
(10) Pub. No.: US 2017/0316488 A1
(43) Pub. Date: Nov. 2, 2017

(54) Systems and Methods of Food Management

(71) Applicants: Alexander Michael Kremen, San Francisco, CA (US); Michelle Esteban, San Francisco, CA (US)

(72) Inventors: Alexander Michael Kremen, San Francisco, CA (US); Michelle Esteban, San Francisco, CA (US)

(21) Appl. No.: 15/482,713

(22) Filed: Apr. 8, 2017

Related U.S. Application Data
(63) Continuation-in-part of application No. 14/732,735, filed on Jun. 7, 2015.
(60) Provisional application No. 62/320,589, filed on Apr. 10, 2016.
(60) Provisional application No. 62/403,715, filed on Oct. 4, 2016.

(51) Int. Cl. G06Q 30/06; G06F 17/30

(52) U.S. Cl. CPC G06Q 30/0633; G06F 17/30525

(57) ABSTRACT

A method, system, and apparatus for food management is provided. A first amount of a first ingredient and a second amount of a second ingredient are identified from at least one user selection within a graphical user interface. An ingredient database specifying ingredients and a set of characteristics defining each ingredient is accessed, where at least a portion of the ingredients are each defined by a density value of the respective ingredient. A first characteristic associated with the first ingredient and a second characteristic associated with the second ingredient is identified within the ingredient database. A result is automatically calculated in response to the at least one user selection within the graphical user interface, wherein the result is calculated based on the first characteristic and the second characteristic.

### PRIORITY

This application claims a priority benefit of U.S. Provisional Application Ser. No. 62/320,589, entitled, “Systems and Methods of Food Management,” filed Apr. 10, 2016, the disclosure of which is incorporated by reference herein in its entirety.

This application also claim a priority benefit of U.S. Provisional Application Ser. No. 62/403,715, entitled, “Systems and Methods of Food Management,” filed Oct. 4, 2016, the disclosure of which is incorporated by reference herein in its entirety.

### BACKGROUND

Meal planning is often a tedious task, especially in households with several people. In some cases, the act of planning meals (e.g., researching recipes, grocery shopping, etc.) can take hours.

### BRIEF DESCRIPTION OF DRAWINGS

The present disclosure is illustrated by way of example and not limitation in the figures of the accompanying drawings, in which like references indicate similar elements and in which:

FIG. 1 is a block diagram depicting an architectural overview of a system for food management, in accordance with an example embodiment;

FIG. 2 is a block diagram depicting an example computing device for food management, in accordance with an example embodiment;

FIG. 3 is a flow chart showing an example method for food management, in accordance with an example embodiment;

FIG. 4 is a block diagram of a machine in the example form of a computer system within which a set of instructions, for causing the machine to perform any one or more of the methodologies discussed herein, may be executed, according to some embodiments;

FIGS. 5-19 are interface diagrams of example user interfaces for creating recipes;

FIGS. 20-22 are interface diagrams of example user interfaces for planning a meal;

FIGS. 23-29 are interface diagrams of example user interfaces for generating a grocery list; and

FIGS. 30-34 are interface diagrams of example user interfaces for generating a grocery list for multiple planned meals.

### DETAILED DESCRIPTION

The description that follows includes illustrative systems, methods, apparatuses, and techniques that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known structures and techniques have not been shown in detail.

Some embodiments described herein provide techniques for food management. A user may manage one or more recipes via a computing device, and the user's recipes may be used to create a meal plan for the user. A meal plan may specify one or more recipes. In some embodiments, a meal plan may specify one or more recipes to be prepared for each meal during a particular duration of time. For example, the user may create a meal plan for a given week, where the meal plan specifies which recipes the user would like to prepare for each meal of that week. The term “meal” may refer to one or more recipes, dishes, and/or drinks to be prepared for a particular time period (e.g., breakfast, lunch, afternoon snack, dinner, etc.). In some embodiments, a meal may refer to one or more dishes that are already prepared and ready to eat (e.g., a frozen dinner). The term “recipe” may refer to a set of instructions that specifies how to prepare a particular dish and/or drink as well as the ingredients, and the amount of each ingredient, to be used in preparing the dish. The term “ingredient” may refer to any element or component of a food item, a dish, and/or drink (e.g., milk, eggs, sugar, a box of macaroni and cheese, a recipe, a frozen meal, a cheese cracker, a cookie, a bagel, an orange peel, a shelled shrimp, a particular candy bar, etc.).

A meal plan may be used to identify ingredients associated with recipes in the meal plan. The identified ingredients may be used to create a grocery list of items to be purchased. In some embodiments, the ingredients may be identified based on an inventory of ingredients the user may already possess. In some embodiments, the identified ingredients may be purchased using the user's computing device, and the order may be fulfilled by one or more providers (e.g., a particular grocery store, a transportation service, etc.) and/or fulfilled by the food management system.

The techniques described above may be facilitated by a food management system. The food management system may be associated with one or more servers that may communicate with computing devices of users of the food management system and computing devices of providers associated with the food management system. In some embodiments, users and providers may register for accounts associated with the food management system, allowing users and providers to access the services provided by the food management system. The services associated with the food management system may be accessed by computing devices of users and providers in any suitable manner, such as via a website, an application (e.g., a mobile application), and the like.

In some embodiments, users may select and/or create a particular meal plan, and the ingredients associated with the meal plan may be automatically ordered and/or delivered. For example, a user may select and/or create a meal plan and click on an order button, where clicking on the button may result in the food management system automatically determining the ingredients to be purchased (e.g., based on the meal plan and/or based on the user's inventory of ingredients) and ordering and/or delivering the ingredients for the user.

In some embodiments, users may create meal plans that may be shared with other users. For example, users may create a meal plan that is specific to certain criteria, constraints, and/or preferences, such as a type of cuisine (e.g., vegetarian, French, low-carbohydrate, etc.). The food management system may allow users to request, search for, and/or view meal plans created by other users such that the meal plans may be used by those users. In some embodiments, a user may allow other users to view, access, and/or use the meal plans created by that user at no cost or for a certain fee (e.g., a subscription fee associated with a particular amount of time, a fee for each meal plan, etc.). In some embodiments, users may tag their meal plans with one or more keywords specifying characteristics of a meal plan for meal plan searching purposes (e.g., type of cuisine, type of diet, ingredients included in and/or excluded from the meal plan, grocery stores selling ingredients for a particular meal plan, a particular genre, a calorie range, a difficulty rating, a price, a number of people and/or servings, etc.). For example, a user searching for meal plans that are vegan may be found based on meal plans that are tagged with the keyword “vegan.” In some embodiments, the food management system may provide various notifications to users regarding available meal plans created by other users. For example, if a user requests a meal plan with a particular set of characteristics, the food management system may notify the user of any meal plans fulfilling those characteristics when those meal plans become available.

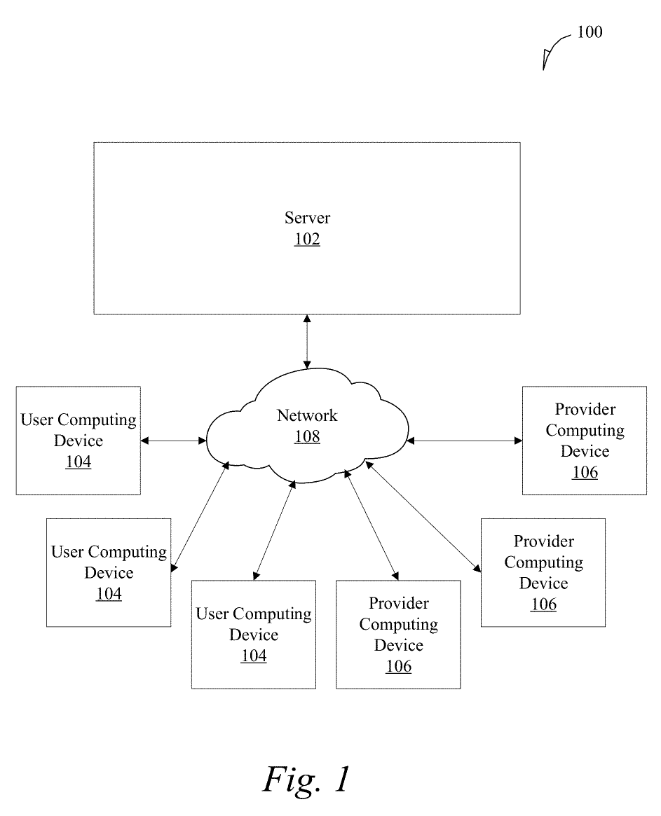

FIG. 1 is a block diagram depicting an architectural overview of a system 100 for food management. In some embodiments, the system 100 comprises a server 102, user computing devices 104, and provider computing devices 106. The components of the system 100 may be connected directly or over a network 108, which may be any suitable network. In various embodiments, one or more portions of the network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The system 100 may include any number of user computing devices 104. In some embodiments, a user computing device may be associated with a user of a food management service provided by the server 102 (e.g., a user using the food management service to create meal plans, plan meals, order ingredients, etc.). A user may be an individual and/or any suitable entity (e.g., a business). The user computing device 104 may be any suitable computing device, such as a smart phone, a personal digital assistant (PDA), a mobile phone, a personal computer (PC), a laptop, a virtual reality device, a computing tablet, a wearable device, or any other device suitable for accessing features associated with the server 102. The user computing device 104 may access the server 102 or the provider computing devices 106 directly, via network 108, or via a third-party system. For example, the user computing device 104 may access the provider computing devices 106 via the server 102. In some examples, a user computing device 104 may access the server 102 and/or the provider computing devices 106 using a web browser application and/or a mobile application on the user computing device 104. In mobile application examples, the user computing device 104 may have downloaded and installed a mobile application having code to perform functionality associated with food management services.

The system 100 may include any number of provider computing devices 106. A provider computing device 106 may be a computing device associated with any suitable provider of a product and/or a service, such as food suppliers (e.g., grocery stores, restaurants with leftover supplies, specialty food stores, etc.), transportation service providers (e.g., ride-sharing service providers, delivery service providers, etc.), and the like. The provider computing device 106 may also be any suitable computing device, such as a server computing device, a smart phone, a PDA, a mobile phone, a personal computer, a laptop, a computing tablet, or any other device suitable for providing products and/or services. The provider computing device 106 may access the server 102 or the user computing devices 104 directly, via network 108, or via a third-party system. For example, the provider computing device 106 may access the user computing devices 104 via the server 102. In some examples, a provider computing device 106 may access the server 102 and/or the user computing devices 104 using a web browser application and/or a mobile application on the user computing device 104. In mobile application examples, the provider computing device 106 may have downloaded and installed a mobile application having code to perform functionality associated with food management services.

The server 102 may include a network-addressable computing system that may provide food management services, as described above. For example, server 102 may manage user and/or provider accounts, recipes, meal plans, calendars, grocery lists, ingredient purchases, recipe preparation, preferences, rankings, a data-driven view of the user, notifications to users, and the like. The server 102 may include any number of servers and may be any suitable server within any suitable environment (e.g., a cloud computing environment).

In some examples, the server 102 may be a platform for food management services as described in more detail below, where the server 102 may include one or more servers that each manage one or more aspects and/or features of the platform. For example, the server 102 may include any one or a combination of servers providing the functionality for the food management platform. In some examples, the server 102 may include one or more servers managing the backend compute for the platform, include the backend compute for a website (e.g., cloud-based compute such as Amazon Elastic Compute Cloud™ (Amazon EC2™)or an on-premises server for compute, etc.) and/or a mobile application (e.g., on-premises server for compute and/or cloud-based compute such as Amazon EC2™, Parse™, or a container-based implementation such as a Heroku™ dyno, etc.) providing the functionality of the platform to users and/or providers. In some examples, the backend compute for the platform may be a container-based implementation providing communication with other services utilized by the platform, such as location services, push notification services, payment services, and the like. In some examples, the server 102 may include one or more servers managing file storage (e.g., an on-premises data store, cloud-based storage such as Amazon Simple Storage Service™ (Amazon S3™), etc.). In some examples, the server 102 may include one or more servers managing relational and/or non-relational databases (e.g., on-premises databases, cloud-based databases such as Parse™ or mongoDB®, etc.), such as databases for managing user and/or provider accounts, an ingredient framework database, and the like. In some examples, the ingredient framework database may also be stored as part of a food management mobile application on a user computing device 104 and/or a provider computing device 106. In such examples, when a user and/or a provider access the food management mobile application, the mobile application may communicate with a server 102 to synchronize the database on the user or provider's computing device to ensure the database on the device has the same information as the database on the server 102. In some examples, a user computing device 104 and/or a provider computing device 106 may access the functionality provided by the food management platform via a mobile application and/or a web browser.

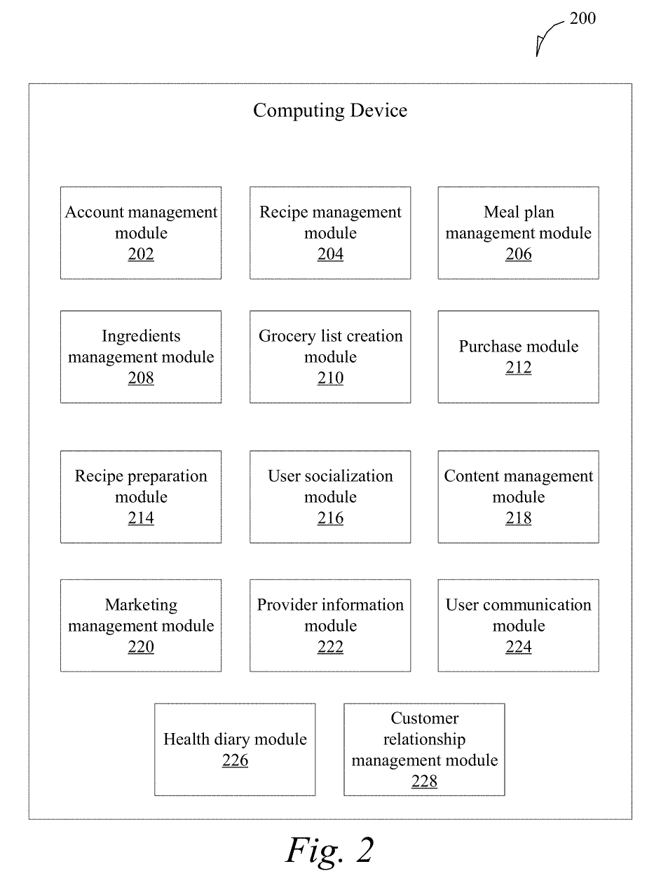

FIG. 2 is a block diagram depicting an example computing device 200 for food management. In some embodiments, the computing device 200 (and/or one or more components shown in FIG. 2) may be, or may be part of, the server 102 of FIG. 1. In some embodiments, one or more components shown in FIG. 2 may be part of an application running on the user computing device 104 of FIG. 1 (e.g., on a mobile application). The computing device 200 may include account management module 202, recipe management module 204, meal plan management module 206, ingredients management module 208, grocery list creation module 210, purchase module 212, recipe preparation module 214, user socialization module 216, content management module 218, marketing management module 220, provider information module 222, user communication module 224, health diary module 226, and customer relationship management module 228. The components of the computing device 200 may allow a user to manage their food by managing recipes, creating meal plans, purchasing ingredients, tracking nutritional information and health goals, and the like.

The account management module 202 may be a hardware-implemented module that may manage and control accounts associated with users and/or providers. The account management module 202 may allow users and/or providers to create their respective account, create and manage profiles associated with the account (e.g., create and manage personalized pages associated with the user and/or provider), connect the account with other users and/or providers associated with the food management system and/or third-party social networking sites, synchronize the account with a third-party service (e.g., a website, application, etc.), specify whether the account is associated with a content provider (e.g., a user who provides content, such as recipes, videos, pictures, etc.), specify a user's preferences and/or favorite content, specify a user's settings (e.g., privacy settings), specify payment information (e.g., credit card account information), and the like.

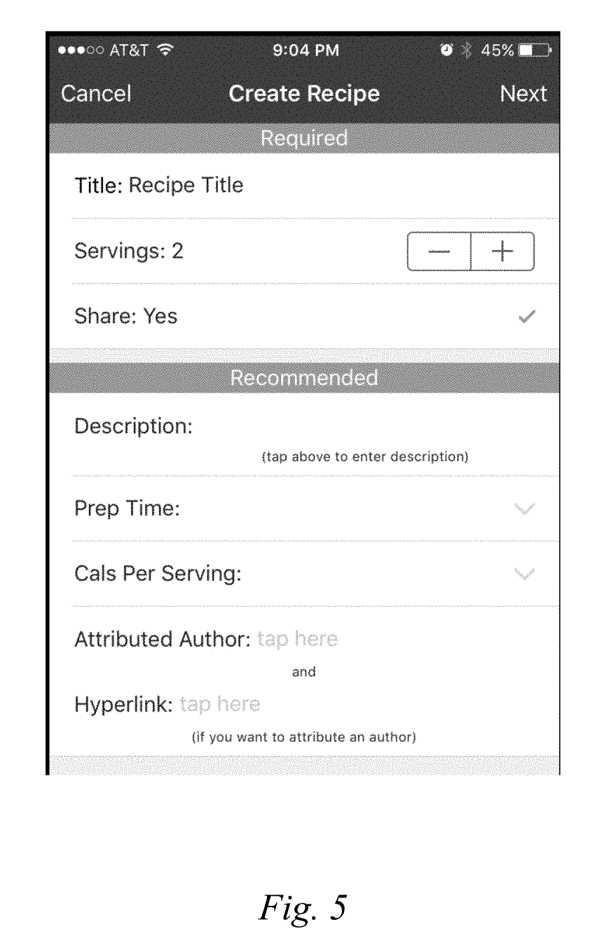

The recipe management module 204 may be a hardware-implemented module that may manage and control recipes. The recipe management module 204 may maintain a database of recipes available to users. The database of recipes may include recipes from any source, such as the food management system itself, third-party websites, users, providers, and the like. In some embodiments, the database of recipes may include any user-generated recipes. In some embodiments, a user may use their computing device (e.g., an application on the computing device) to provide one or more recipes in any suitable manner, such as manually inputting the recipe (e.g., see FIGS. 5-19, which are interface diagrams of example user interfaces for creating recipes), submitting an image of the recipe (e.g., added using optical character recognition (OCR)), importing a recipe shown on a third-party website (e.g., via an application programming interface (API)), and the like.

In some embodiments, the recipe management module 204 may automatically suggest ingredients as the user manually inputs a particular recipe. For example, if the user begins to input “ap” into an ingredient search bar, the recipe management module 204 may automatically retrieve ingredients that begin with “ap,” such as apple.

In some embodiments, the recipe management module 204 may provide recipe suggestions to users in any suitable manner. For example, a sponsor of a particular recipe may pay the food management system to suggest their recipe to users, or the food management system may use a computer-learning algorithm to predict recipes that a user may like based on past behavior (e.g., based on user-provided ratings of recipes, based on recipes that the user prepares at a particular frequency, etc.) using any suitable mechanism (e.g., a recommender system using collaborative and/or content-based filtering, etc.) and may suggest the predicted recipes to the user. In some embodiments, the recipe management module 204 may provide recipe suggestions based on user-specified preferences, ingredient prices, and/or availability of various ingredients. In some embodiments, the recipe management module 204 may automatically create a meal plan for a user based on a set of user-specified preferences and/or constraints. In some embodiments, the recipe management module 204 may suggest drink pairings (e.g., cocktail recipes) to pair with various recipes.

The recipe management module 204 may allow a user to search the recipe database (e.g., stored on the server 102 and/or on the user's own computing device) for various recipes and/or meal plans, and the database may be searchable based on any suitable criteria. For example, the database may be searchable by tags associated with recipes, various categories associated recipes (e.g., brunch, football game appetizers, Thanksgiving dinner, French food, healthy food, unhealthy food, food associated with a particular diet, etc.), and the like. In some embodiments, the recipe management module 204 may allow users to subscribe to various meal plans, chefs, celebrities, teachers and/or educational companies, or any other entities that create and/or provide recipes and/or meal plans to users. In some embodiments, the user may subscribe to such entities by paying a particular fee to the food management system and/or to the entity.

The recipe management module 204 may allow a user to associate one or more recipes with their account (e.g., add a recipe to a list of favorite recipes). In some embodiments, the recipe management module 204 may allow a user to customize recipes, ingredients, and meal plans that may have been provided to the user in any suitable manner (e.g., automatically, by suggestion, via a third-party website, etc.). In some embodiments, a user may customize ingredients in recipes manually and/or based on user-specified criteria relating to customization of ingredients, such as specifying that a particular ingredient in any recipe is to be replaced with another specified ingredient. For example, the user may provide user-specified criteria that indicates that any instance of broccoli in a recipe is to be replaced with Brussel sprouts, and any broccoli in recipes will automatically be replaced with Brussel sprouts based on the user-specified criteria. In some embodiments, a user may, manually and/or based on user-specified criteria, customize meal plans based on any suitable schedule (e.g., the user's schedule, schedules of people in the user's household, etc.).

In some examples, the recipe management module 204 may allow users to customize and save any recipe. For example, the recipe management module 204 may allow a user to create another version of a recipe by editing an existing recipe and saving the edited version. In some examples, a user editing an existing recipe may also specify how the recipe was edited (e.g., edited by adding more pepper to the recipe). Versions of recipes may be related in a relational database, where each recipe within a family of related recipes is related in the database based on identifiers associated with each recipe. Each recipe in a family of recipes may indicate attribute data and relativity data, where attribute data is information associated with a particular attribute that was modified (e.g., an ingredient, a tag, a step in the instructions, a characteristic of the recipe, etc.) and where relativity data is information associated with how the attribute was changed from one recipe to another (e.g., greater than, less than, etc.). Attribute data may be based on a particular recipe attribute (e.g., an ingredient) and/or an attribute characterized by a user (e.g., how healthy a recipe is relative to another recipe). For example, a subsequent version of a recipe in a family of related recipes may have more pepper than the original recipe in the family of related recipes and may be healthier than the original recipe. In this case, the attribute data may indicate that the attribute is the ingredient pepper as well as the characteristic of healthiness, and the relativity data may indicate a “greater than” relationship between the subsequent version of the recipe and the original recipe. In some examples, a particular recipe may also include recommendations for related recipes, including recipes within the same family of recipes, recipes that may be similar to the particular recipe (e.g., similar based on ingredients, instructions, tags, etc.), and the like. In some examples, these recommendations may also indicate any attribute data and relativity data.

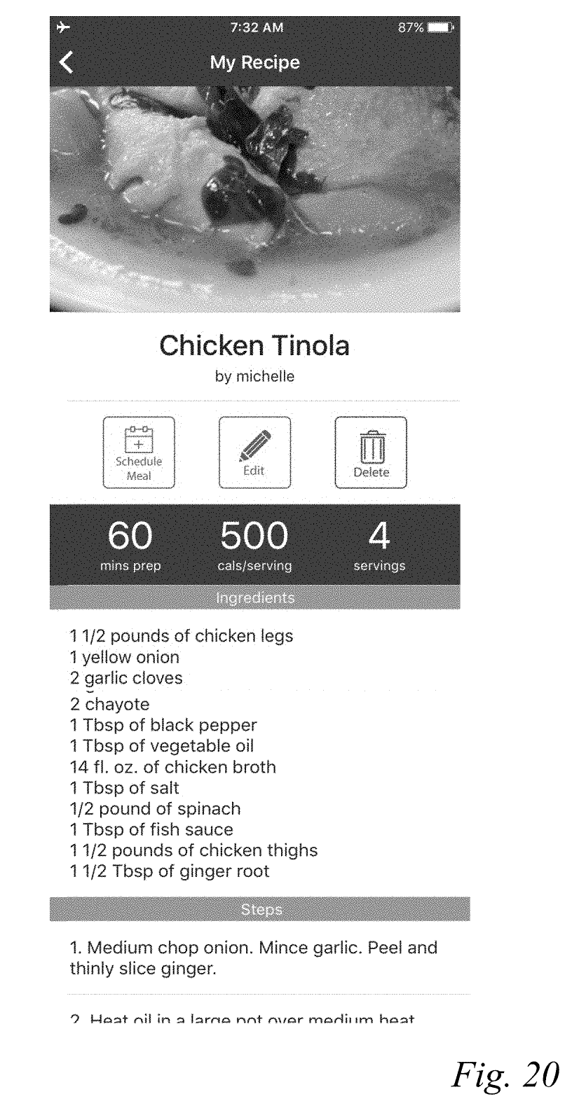

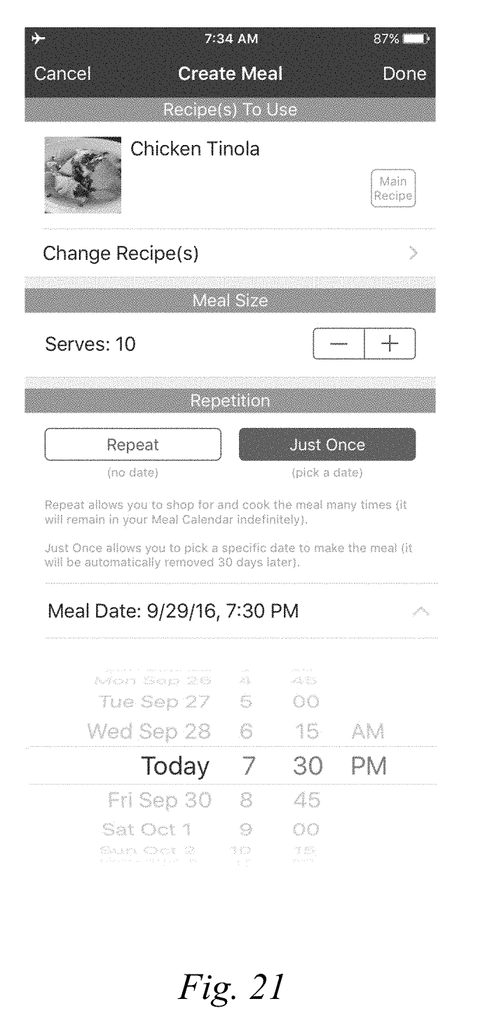

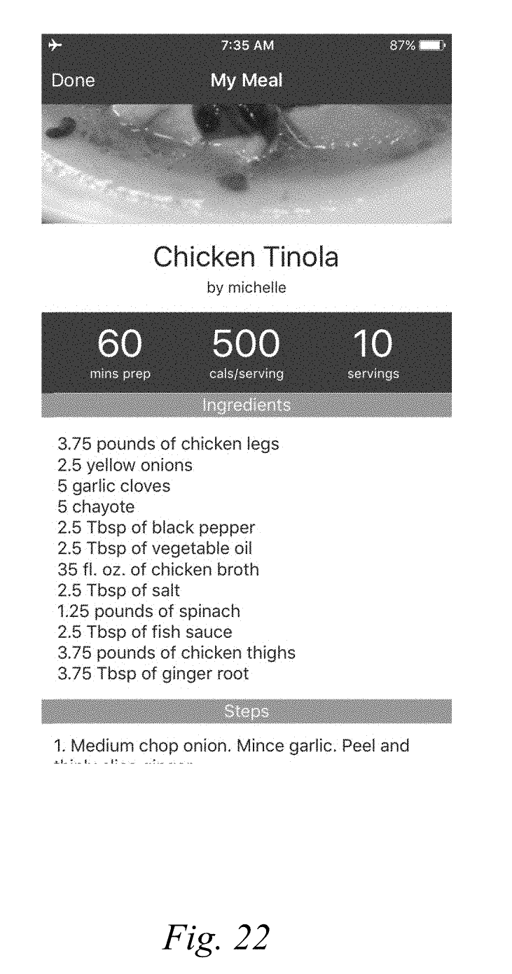

The meal plan management module 206 may be a hardware-implemented module that may manage, control, and facilitate the creation of meal plans associated with a user account. The meal plan management module 206 may allow a user to create a meal plan for a particular duration of time by allowing the user to select various recipes to add for each meal of the meal plan (e.g., FIGS. 20-22 show using a recipe for 4 servings (FIG. 20) to create a meal plan (FIG. 21) that scales the recipe for 10 servings (FIG. 22) for a particular time). For example, a user may specify which recipes to prepare for each meal in the meal plan, where a meal may include one or more recipes (e.g. by selecting recipes using the “Change Recipe(s)” button in FIG. 21). A user may also specify how many servings of each meal the user would like to prepare. For example, if a user plans to prepare a particular meal for a dinner party, the user may specify the number of people attending the dinner party such that the number of servings associated with each meal in the recipe may be determined and accounted for.

In some embodiments, if a user account specifies that the user is associated with a particular diet (e.g., vegetarian, vegan, low-carbohydrate, low-calorie, etc.), the meal plan management module 206 may access data associated with the specified diet and may suggest meals plans that follow the specified diet, recipes that follow the specified diet, other users associated with the specified diet, and/or providers associated with the specified diet. For example, the meal plan management module 206 may access nutritional information associated with various recipes, identify recipes that are aligned with the user's particular diet, and recommend meal plans using the identified recipes in the user's meal plan. In some embodiments, the nutrition information for various recipes may be provided to the user. In some embodiments, the meal plan management module 206 may suggest meal plans based on past user behavior. In some embodiments, if a user creates a meal plan for a portion of a particular amount of time associated with the meal plan, the meal plan management module 206 may provide suggestions for recipes to complete the meal plan. In some embodiments, the meal plan management module 206 may communicate with other third-party services (e.g., third-party application) to receive and/or send data associated with meals plans, such as data associated with what to eat, how to create a meal plan, diet-specific meal ideas, whether a particular meal plan fits a particular diet restriction, and the like.

In some embodiments, the meal plan management module 206 may intelligently determine whether certain ingredients in the user's meal plan may be used to prepare other recipes in the user's meal plan. For example, if a meal plan uses half an onion for a particular recipe, the meal plan management module 206 may suggest other recipes to use in the meal plan that include the other half of the onion such that the ingredients may be maximized instead of wasted. In some embodiments, this may be performed based on the user's inventory of ingredients, ingredients the user may purchase, serving sizes for meals, and the like. In some embodiments, the meal plan management module 206 may identify ingredients that the user already possesses in the user's inventory and may suggest various recipes to add to the user's meal plan based on that inventory and/or based on the user's preferences, past behaviors, ingredient prices at local grocery stores, and the like.

In some embodiments, the meal plan management module 206 may receive a request for a meal plan, where the request may specify criteria associated with a first account of a user. For example, a user may specify various criteria for a meal plan that the user wishes to request, such as specifying that the user wishes to request a vegetarian meal plan for two people. In response to the request, the meal plan management module 206 may send display data to display a set of meal plans, where each meal plan in the set of meal plans is associated with a particular user and may fulfill at least a portion of the criteria. For example, each meal plan displayed may be a meal plan associated with a particular user who created the meal plan, and each meal plan displayed may be a meal plan that fulfills at least some of the criteria specified by the request. In some embodiments, the meal plans may be displayed in a particular order, such as in an order that is based on a degree to which the specified criteria are fulfilled. The meal plan management module 206 may receive a user selection identifying a first meal plan from the set of meal plans, where the first meal plan is associated with a second account of a second user and specifies one or more recipes. For example, the user may provide a user selection identifying the meal plan that the user chooses from the set of meal plans displayed. The meal plan management module 206 may then associate the first meal plan with the first account of the user in response to the user selection such that the user may access and use the first meal plan. In some embodiments, the meal plan may be transferred from the account of the second user (e.g., the user who created the meal plan) to the account of the first user (e.g., the user who requested the meal plan). In some embodiments, the meal plan may be a specific set of recipes, where the specific set of recipes are transferred from the account of the second user to the account of the first user. In some embodiments, the meal plan may be associated with recipes relating to the meal plan, where each recipe associated with the meal plan may be transferred from the account of the second user to the account of the first user over a period of time. For example, a set of recipes associated with the meal plan may be transferred daily.

The ingredients management module 208 may be a hardware-implemented module that may manage and control the determination of ingredients for various recipes. For example, the ingredients management module 208 may identify ingredients associated with a user's meal plan, including identifying amounts of ingredients to be used in recipes specified by the user's meal plan.

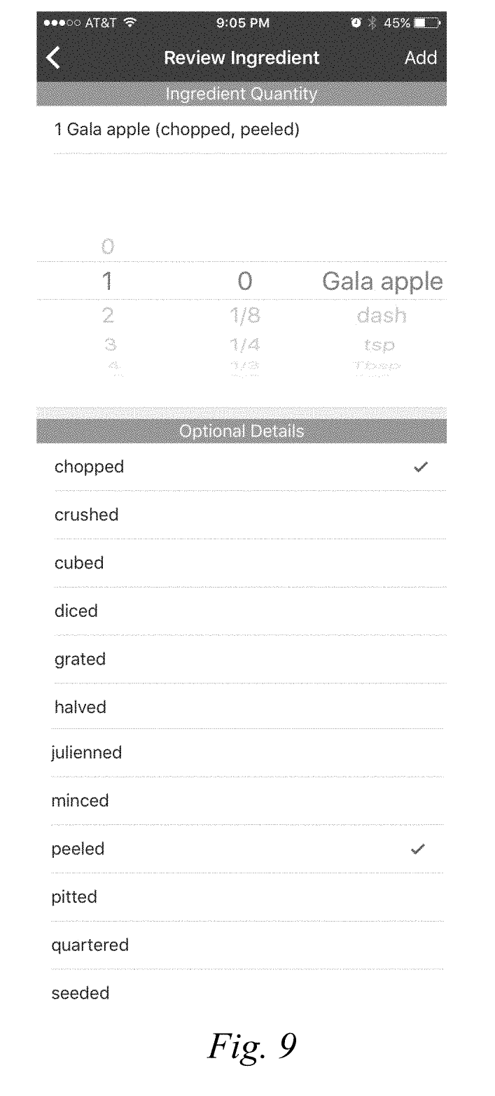

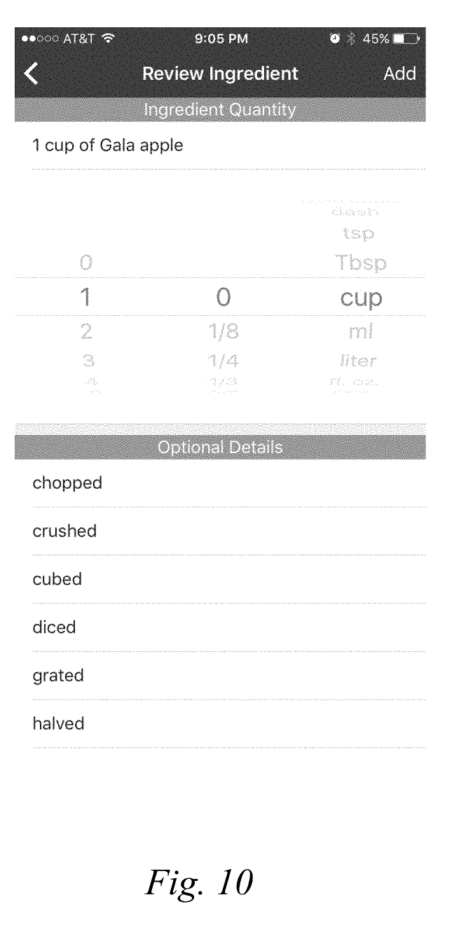

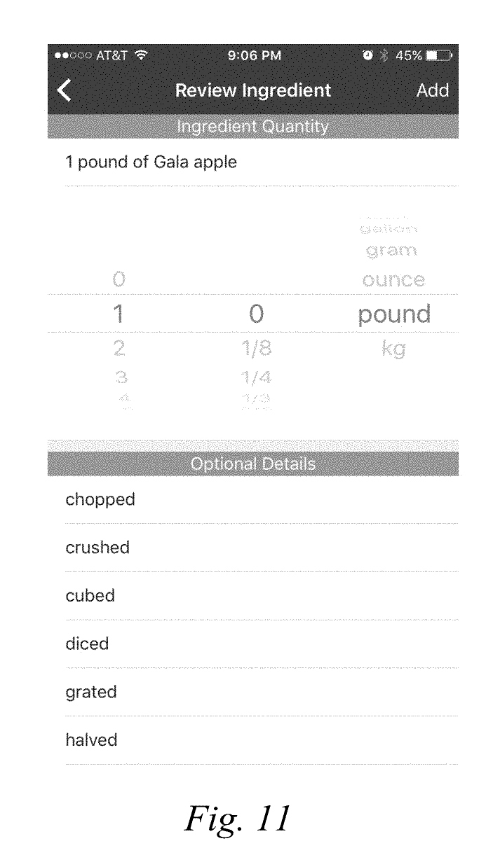

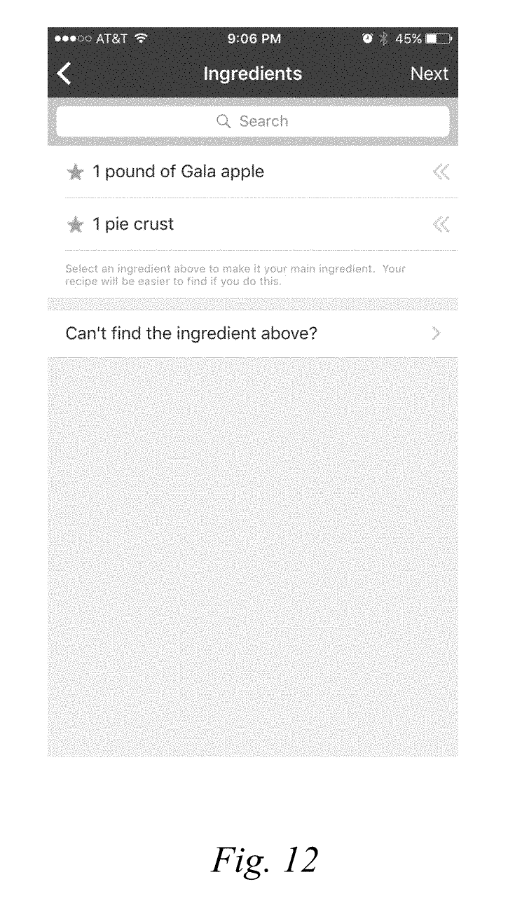

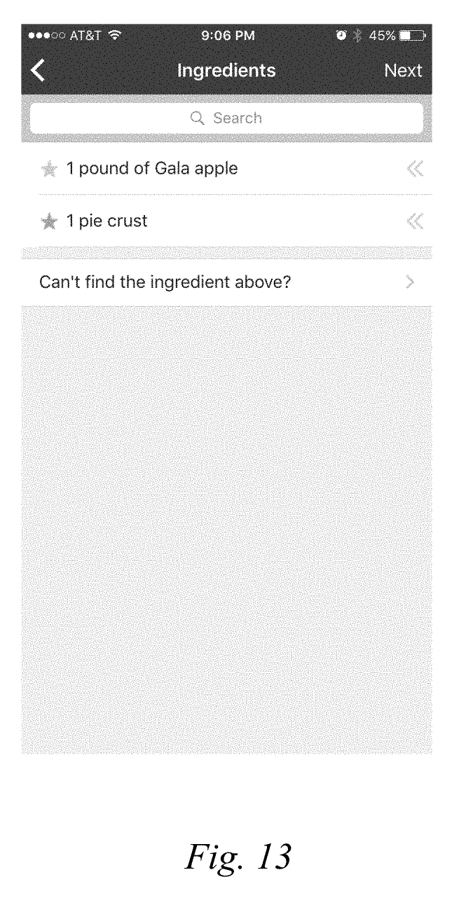

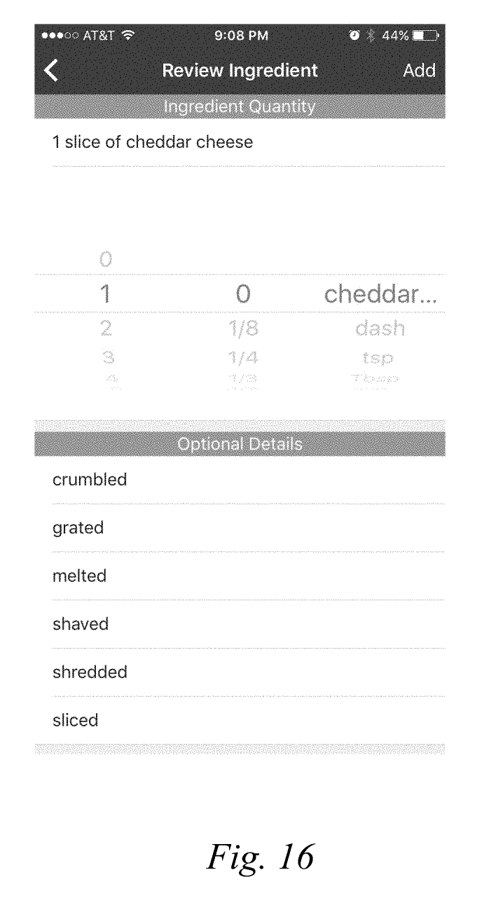

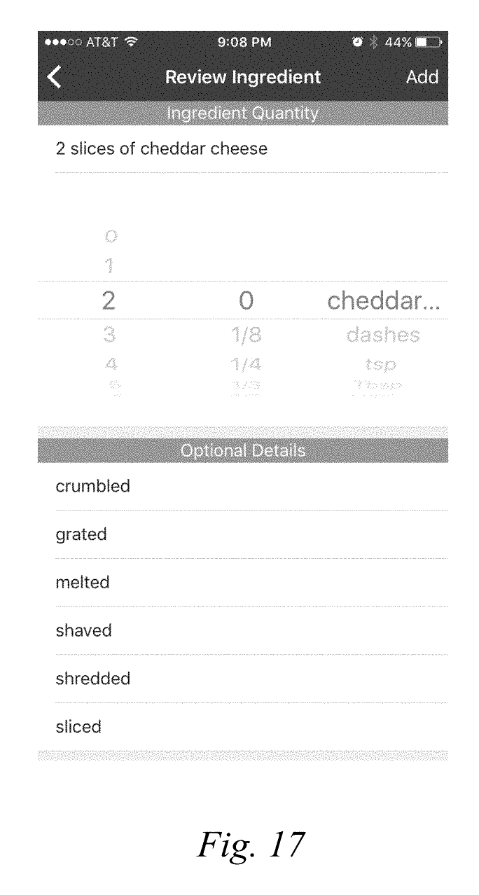

The ingredients management module 208 may manage a data store of information relating to ingredients that may be used in recipes. The ingredients management module 208 may include a database of ingredients, where each ingredient entry in the database may be associated with data relating to that ingredient. For example, an entry for a particular ingredient (e.g., apple) may include a unique object identifier for that entry, a singular description for the ingredient when the ingredient is referenced in its singular form (e.g., apple), a plural description for the ingredient when the ingredient is referenced in its plural form (e.g., apples), an ingredient group associated with the ingredient (e.g., Fruit), a density associated with the ingredient (e.g., the grams per milliliter of an apple), information associated with the seasonality of the ingredient (e.g., an indication of months in which the ingredient is in season), an image of the ingredient, a three-dimensional representation used to render a three-dimensional visualization of the ingredient, a flavor profile of the ingredient (e.g., sweet, salty, bitter, etc.), other names (e.g., nicknames, names in different languages, etc.) for the ingredient (e.g., a user may refer to cilantro as coriander), nutritional information associated with a particular amount of the ingredient (e.g., calories, carbohydrates, fat, protein, vitamins, etc.), whether the ingredient can be purchased in a canned or a jarred version (e.g., canned tuna), a drained and/or a net weight associated with canned or jarred ingredients, information associated with various sizes of an ingredient (e.g., a small apple, a medium apple, a large apple) and respective minimum and maximum weights and/or volumes for each of those sizes, a packed and/or an unpacked weight and/or volume amount for each item (e.g., a packed cup of brown sugar), an indication of whether the ingredient is typically sold as a weight or volume, one or more Universal Product Codes (UPCs) associated with the ingredient, allergy information associated with the ingredient (e.g., dairy-free, peanut allergy-free, etc.), food types and/or diets associated with the ingredient (e.g., vegetarian, vegan, meat, etc.), and the like. In some examples, an ingredient entry may also include a description of each of its parts and information (e.g., a density value, nutritional value, etc.) associated with each of those parts. For example, the ingredient entry for apple may include a description of each of its parts (e.g., peel, core, seeds, etc.) and may include any additional information associated with each of those parts (e.g., a density value for each part, a nutritional value for each part, etc.) and/or additional information associated with the generic ingredient itself. Other examples of descriptions of an ingredient's parts include whether an ingredient is pitted, trimmed, destemmed, and/or shelled. In some examples, an ingredient entry may also include various types of the ingredient. In some examples, each of the types of ingredients may include any additional information associated with each of those types (e.g., a density value for each part, a nutritional value for each type, etc.) and/or may include additional information associated with the generic ingredient itself. For example, the ingredient entry for apple may include various types of apples (e.g., Gala, Fuji, Granny Smith, etc.), and each type of apple may be associated with a particular density value, nutritional value, and the like. In some examples, an ingredient entry may also indicate whether the ingredient can be described as a fraction of itself (e.g., a ring, a circular slice, a segment, a peel, a leaf, etc.). In some examples, each ingredient may be represented in a hierarchical manner. For example, the ingredient entry for an apple may be associated with types of apples, each type of apple may be associated with the various parts of the particular type of apple, each part of the particular type of apple may be associated with nutritional values and/or a density value for that part, each type of apple may be associated with various fractions of itself, each fraction of the apple may be associated with nutritional values and/or a density value for that part, and the like. Each entry for an ingredient may also include a standard unit of measure associated with the ingredient that indicates how an ingredient is typically described in a recipe, such as a weight as shown in FIG. 11 (e.g., 1 pound of apples), a volume as shown in FIG. 10 (e.g., 1 cup of apples), or the item itself as shown in FIG. 9 (e.g., 1 apple). If an ingredient can be represented as an item of itself, each entry for an ingredient may also include an average and/or approximate weight of the ingredient (e.g., 4.8 ounces for each apple). Each entry for an ingredient may also include an extra singular phrase that may be associated with the ingredient as well as an extra plural phrase that may be associated with the ingredient. For example, for the ingredient cheddar cheese, the entry for cheddar cheese may include the extra singular phrase “slice of” and the extra plural phrase “slices of” to represent “1 slice of cheddar cheese” (e.g., FIG. 16) or “2 slices of cheddar cheese” (e.g., FIG. 17) in recipes. Each entry for an ingredient may also include one or more characteristics associated with the ingredient, which may help a user find recipes that include ingredients relating to the associated characteristics. For example, the entry for an apple may include an array of characteristics that includes “Fruit” and “Apple.” If a recipe specifies that the apple ingredient is the main ingredient of the recipe (e.g., as indicated by the selection of a star in FIGS. 12 and 13), that recipe may be returned in search results when a user searches for recipes with the main ingredient being a “Fruit” or an “Apple.”

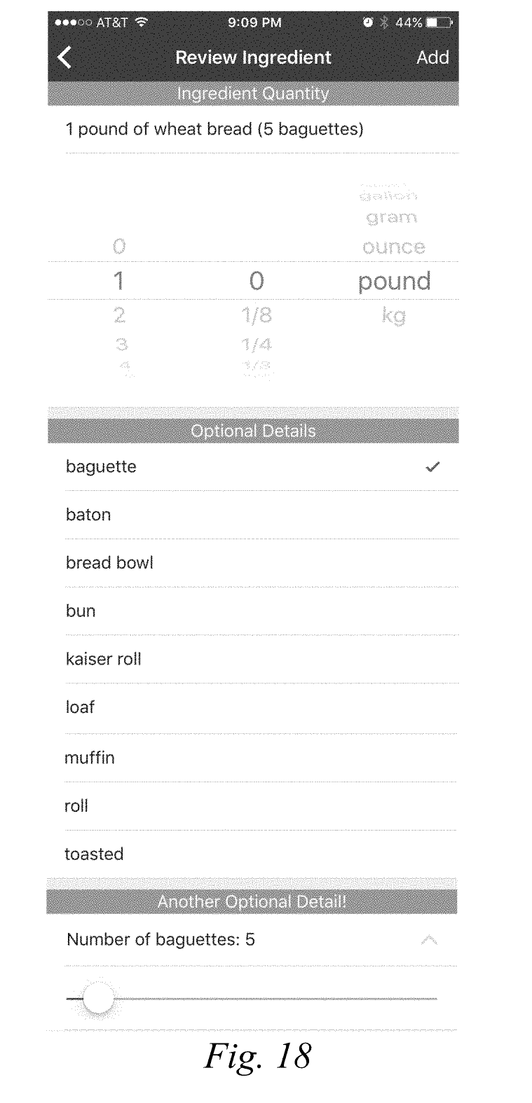

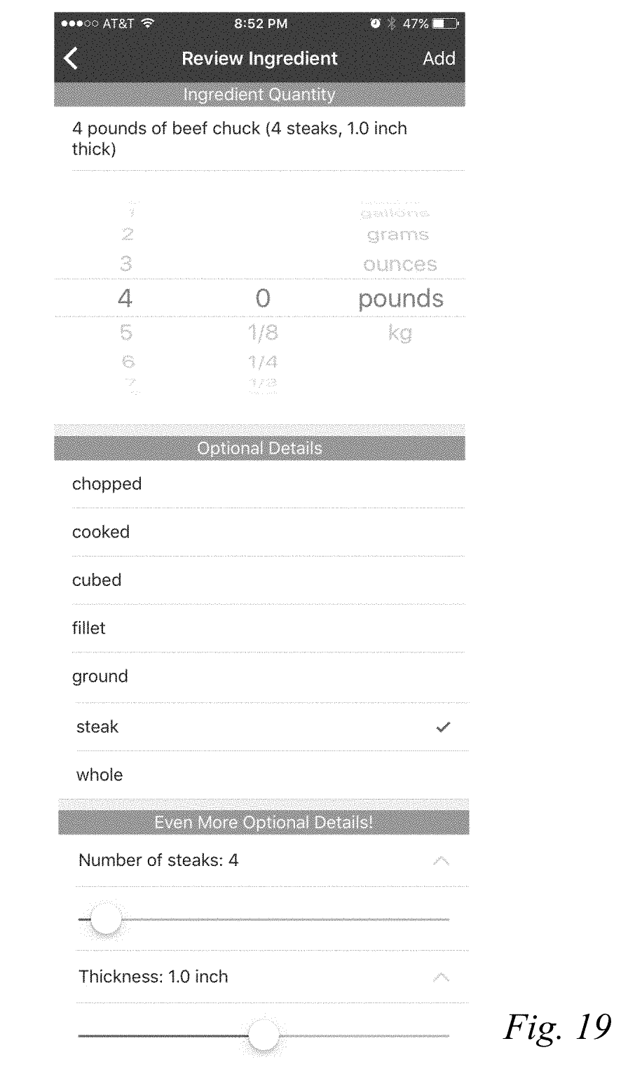

In some examples, each entry for an ingredient may also include values (e.g., Boolean values) for one or more group details relating to a set of qualifiers associated with each group detail, where a group detail may be associated with a group or type of ingredient (e.g., fruit, vegetable, meat, etc.). For example, the entry for the ingredient apple may have a Boolean value set to true for a fruit detail, where the fruit detail may relate to a set of qualifiers that may further refine how an apple is described in a recipe (e.g., chopped, cubed, diced, halved, etc. as shown in FIG. 9). In some examples, the set of qualifiers may be associated with each ingredient entry. In some examples, the set of qualifiers (e.g., chopped, cubed, diced, halved, etc.) for each group detail (e.g., vegetable detail, meat detail, etc.) may be stored in a separate table such that each group detail includes an array of the qualifiers that may be used to further refine how an ingredient can be described in a recipe. In some examples, each qualifier may include an indicator indicating a granularity for how an ingredient is prepared. For example, the indicator may indicate how finely to dice an ingredient. Additionally, each array of qualifiers may be associated with another array of indicators that each indicate whether a corresponding qualifier makes the associated ingredient combinable with similar ingredients from other recipes, for purposes of grocery creation from multiple recipes. For example, qualifiers associated with the group detail for bread may include items such as baguette, baton, bread bowl, and the like. If a recipe specifies wheat bread in the form of a bread bowl, this ingredient may not be combinable with another recipe that specifies wheat bread in the form of a baguette (e.g., FIG. 18). The set of qualifiers may each also be further qualified. For example, a wheat baguette can be further qualified by a number of baguettes (e.g., 1 wheat baguette), or a beef chuck steak can be further qualified by a number of steaks and a thickness of each steak (e.g., 4 pounds of beef chuck (4 steaks, 1 inch thick) shown in FIG. 19).

The data associated with each ingredient entry may be used for any suitable purpose and may provide the food management system with a robust set of features. The data associated with each ingredient may be used to specify how the ingredient is to be displayed within a recipe (e.g., singular, plural, chopped, volume versus weight versus item, etc.), how the ingredient can be combined in a grocery list (e.g., via its density value), and the like. The data associated with each ingredient entry may be used to provide various format options to a user entering ingredients for a recipe while allowing the ingredients to be combined in a grocery list. For example, a recipe may include “1 apple,” another recipe may include “2 apples, peeled and chopped,” another recipe may include “3 cups of diced apples,” and another recipe may include “4 pounds of apples, chopped.” These recipes may be used to create a grocery list, where the generated grocery list may include a line item for an amount of apples to purchase, instead of four separate apple line items for each recipe. In some examples, the flavor profile associated with each ingredient in a recipe may be used to automatically generate a flavor profile for the recipe. For example, the flavor profiles of each ingredient in a recipe and the amounts of each ingredient in the recipe may be used to calculate a flavor profile for the recipe, which may be included in a description of the recipe.

In some examples, the allergy information, food types, and/or diets associated with an ingredient may be used to determine additional information associated with a recipe. For example, the information associated with the collective ingredients of a recipe may be used to determine whether the recipe as a whole is associated with certain allergy information (e.g., dairy-free), food types (e.g., meat dish), and/or diets (e.g., vegan).

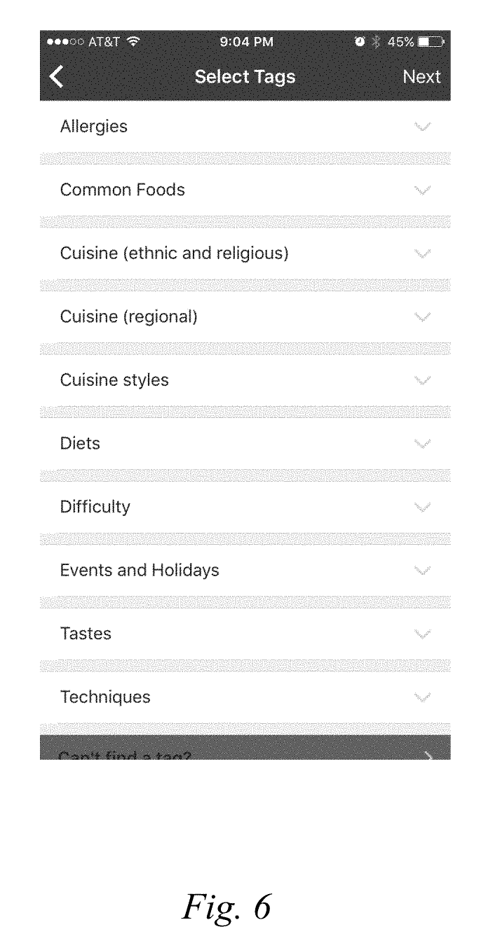

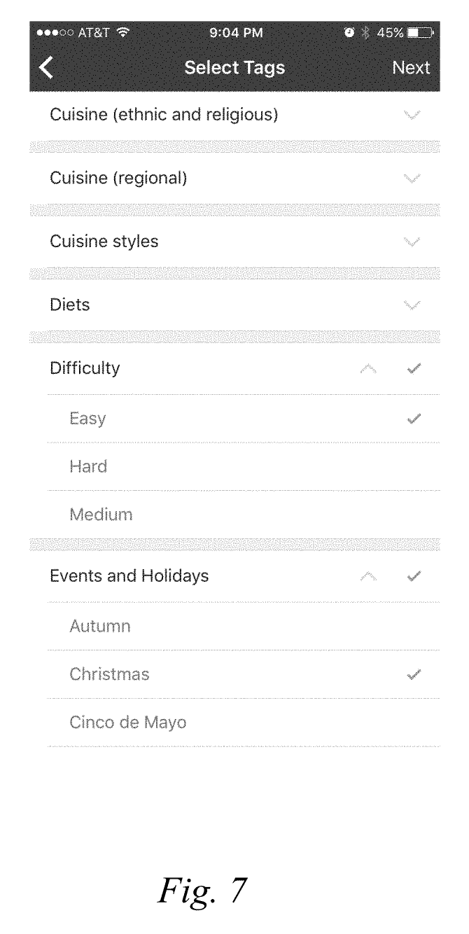

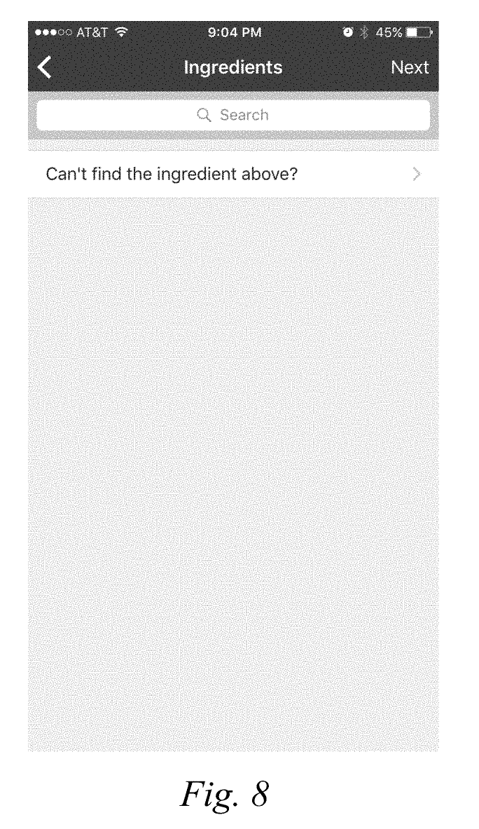

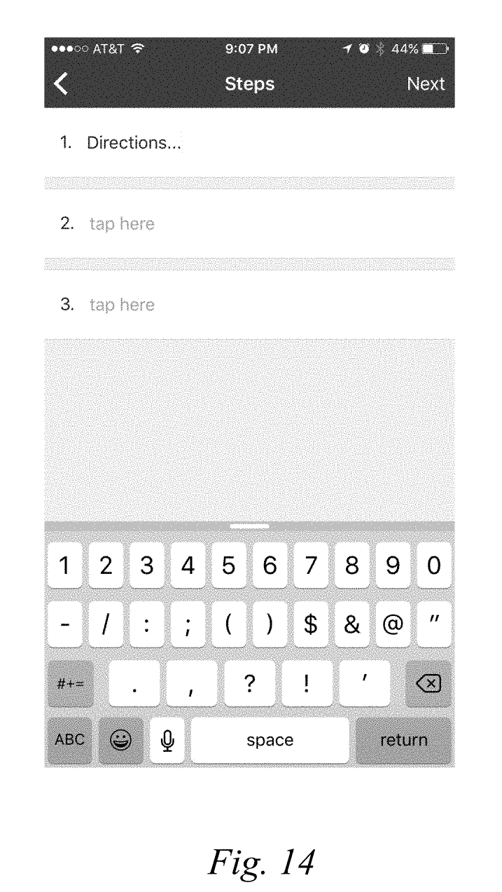

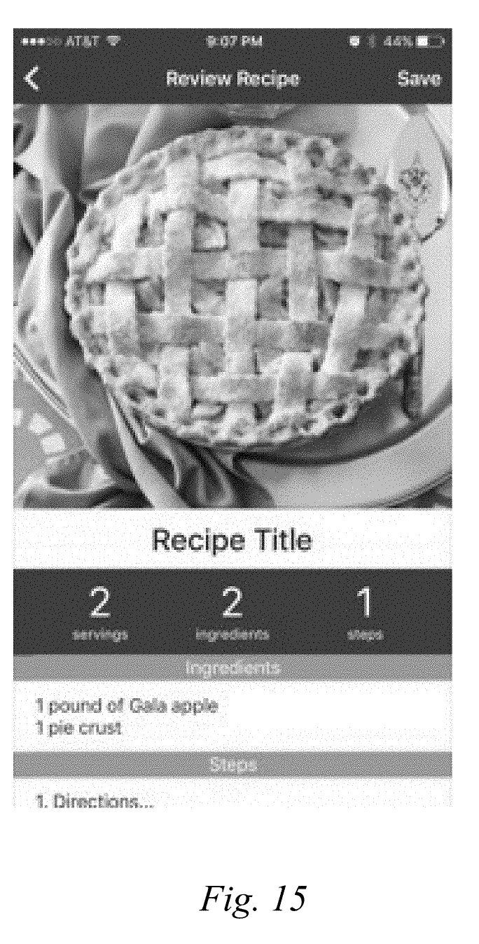

When a user creates a recipe, the recipe management module 204 may manage the information associated with the created recipe. For example, a user may specify information associated with the recipe (e.g., FIG. 5), such as a description, the number of servings, an image (e.g., FIG. 15), the title, tags associated with the recipe such as those shown in FIGS. 6 and 7 (where the tags may also be stored in a table managed by the ingredients management module 204), ingredients for the recipe (e.g., FIGS. 8-13 and FIGS. 16-19), and instructions for preparing the recipe (e.g., FIG. 14), and the recipe management module 204 may store this information with reference to the information managed by the ingredients management module 208. In some examples, the user may also add an image for each step within the instructions of the recipe to show what the recipe being prepared should look like at that stage in the preparation process.

In some examples, the user may also add a time associated with each step within the instructions of the recipe, and that time may be used for any suitable purpose. For example, the time may be used to calculate a total preparation time for the recipe, to coordinate the preparation of multiple recipes being prepared concurrently for a meal, and the like. In some examples, each step in the instructions may be associated with any suitable information, such as the step's start time calculated from the completion of the recipe, the time a person would need to commit to completing the step (e.g., preparation time), the total time it would take to complete the step, an indication of other steps that cannot be started before the step is completed, items to be used for the step (e.g., oven, bowl, etc.), and the like. The items to be used for the step may be used to let the user know what tools may be needed to complete the recipe. The items may also be used to determine which steps can be completed concurrently with other steps or which steps may be started once a previous step is completed. For example, user settings may be used to determine that the user only has one oven, and as such, different steps that utilize the oven at different temperatures cannot be performed concurrently. Using this step information, the steps for multiple recipes may be compiled into a series of steps such that the user may know when each step is to be started relative to the other steps in the recipes to be prepared. In some examples, each step may be cross-referenced with other steps to ensure there is enough time for each step in the series. In some examples, each step may be associated with visual cues that reference the recipe for that step. In some examples, each step may be display with any suitable information, such as items and/or tools associated with the step, how long the step takes to complete, how much time the user will need to prepare the step, which future steps depend on that step's completion, and the like.

In some examples, the completed recipe may be displayed in a user interface that a user may use when preparing the recipe. For example, the user may view the recipe's ingredients and instructions and may be able to click on each step in the instructions when the user has completed that step such that the user may keep track of where they are in the preparation process.

The above-described ingredient framework allows for a variety of functionalities. For example, as described in more detail below, the ingredient framework allows grocery lists to be generated based on multiple recipes such that ingredients for the recipes can be intelligently combined and grouped by ingredient group within the grocery list. In some examples, this may be performed using the density value, weight of a unit of the ingredient, an indicator specifying whether the ingredient is combinable, and/or the ingredient group associated with an ingredient. For example, a grocery list may be generated for a first recipe that specifies a cup of apples, a second recipe that specifies a pound of apples, and a recipe that specifies 3 apples, where the grocery list may use the density value and/or the weight of a single apple to combine the amounts of apples needed for each recipe such that the grocery list specifies one line item for the combined amount of apples, categorized within the “Fruit” group.

The ingredient framework further allows recipes to be scaled based on the number of servings desired for a meal. In some examples, the ingredient framework may adjust how recipes are scaled based on whether the recipe is an appetizer, main course, dessert, and the like, as various dishes may be associated with various serving sizes.

The ingredient framework further allows recipes to be edited in any suitable manner. For example, a user may edit an existing recipe by modifying types and/or amounts of ingredients.

The ingredient framework further allows a user to search for recipes by main ingredient, as referenced by any characteristics associated with a main ingredient of a recipe (e.g., as indicated by the selected star of FIG. 13).

In some examples, the ingredient framework may be in communication with any suitable providers (e.g., grocery stores, delivery services, etc.) to facilitate grocery purchase and delivery (e.g., based on ingredient availability, sales, discounts, seasonality of ingredients, etc.).

In some examples, the ingredient framework, titles for recipes, and/or a tag framework for managing tags that a user can use to tag recipes may be used to facilitate a recommender system to provide recipe recommendations to users based on implicit and/or explicit user actions (e.g., through collaborative and/or content-based filtering), such as a user rating, the user indicating they like a recipe, the user viewing a particular recipe, and the like.

In some examples, the ingredient framework may be used to generate nutrition facts associated with a recipe. For example, a recipe may include a set of ingredients, and the nutrition facts for the set of ingredients may be determined by combining the individual nutrition facts of each ingredient based on amounts of each ingredient in the recipe. In some examples, certain recipes may specify ingredients that may be used in the cooking process but may not be entirely consumed after preparation of the recipe (e.g., an amount of canola oil for deep frying chicken). In such examples, when a user creates a recipe, the user may be presented with options and/or questions associated with each ingredient for the recipe, where the options and/or questions may be related to how much of the ingredient to attribute to the nutritional facts of the recipe. In such examples, a user may specify that only a portion of that particular ingredient be considered when determining nutrition facts for the recipe (e.g., only use 10% of the nutritional values for canola oil in a recipe that uses the canola oil for deep frying chicken, only account for nutritional values for the parts of an ingredient that are used in the final product of the recipe and not discarded (e.g., a peel)). These nutrition facts may be used to intelligently create and customize meal plans for users who wish to stay within certain ranges with respect to nutritional elements (e.g., under 1200 calories a day). In some examples, a recipe may be used as an ingredient of another recipe (e.g., a recipe for spaghetti sauce may be used as an ingredient for a spaghetti and meatballs recipe), and the nutrition facts for the recipe that is used as the ingredient (e.g., spaghetti sauce) may be calculated into the nutritional values for the recipe containing that ingredient (e.g., spaghetti and meatballs). In some examples, a user may prepare a meal for a group of other users, and portions of the meal's nutritional information may be allocated to the various users (e.g., 10 users each ate 10% of a particular meal, so each user consumed 10% of the nutritional value of the meal), allowing users to track their nutritional consumption. In some examples, a user may tag other users in a meal such that the meal's nutritional value is divided among the tagged users. In some examples, the ingredient framework may be used to track and/or aggregate the user's nutrition in a food journal. For example, as a user plans and prepares recipes and/or meals, the nutritional values for those recipes and/or meals may be automatically tracked for a user. In some examples, the nutritional values may be automatically added to the user's food journal in response to a user input indicating the user actually ate the planned meal. The nutritional information may be used for any suitable purpose, such as to count calories for a diet, compare calories consumed versus calories burned (e.g., through exercise), synchronize with a health device, provide to a personal trainer and/or health coach, and the like.

The grocery list creation module 210 may be a hardware-implemented module that may manage, control, and facilitate the creation of a list of items that the user is to purchase in order to prepare the recipes in the user's meal plan. The list of items may be based on the ingredients identified by the ingredients management module 208, or may be based on the identified ingredients less the ingredients that the user already has in the user's inventory of ingredients. The grocery list creation module 210 may convert ingredients identified by the ingredients management module 208 into a grocery list of items. For example, if the ingredients management module 208 identified that a total of 3 cups of milk are to be purchased for meals during a week, the grocery list creation module 210 may determine that a quart of milk is to be purchased (e.g., based on information associated with UPCs), which would be the smallest amount of milk that may be purchased in order to make the recipes in the meal plan. In some embodiments, a user may specify preferences relating to sizes of items to purchase.

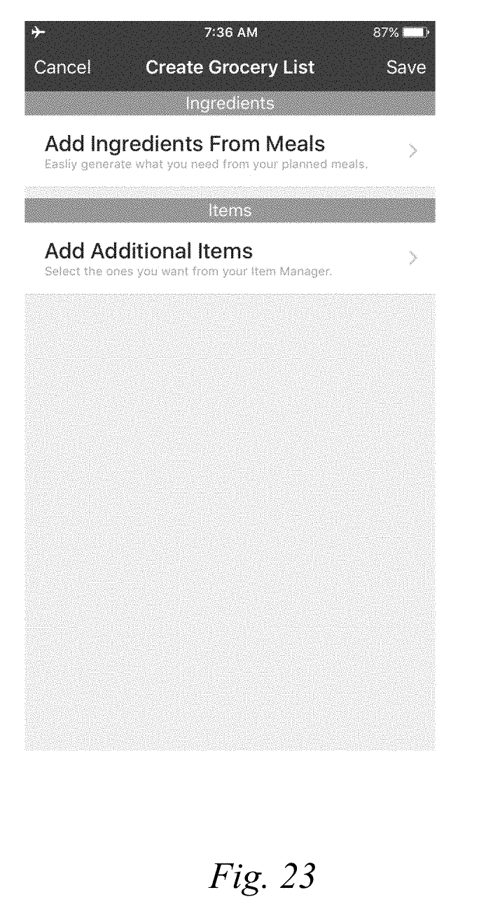

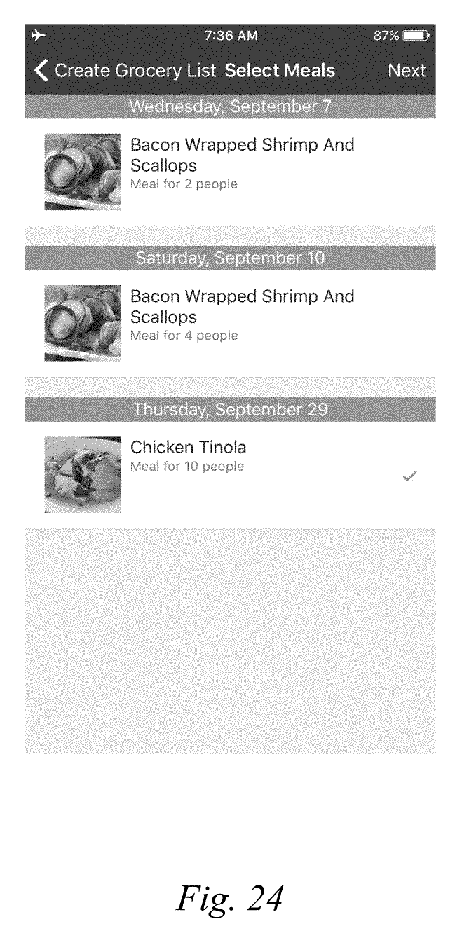

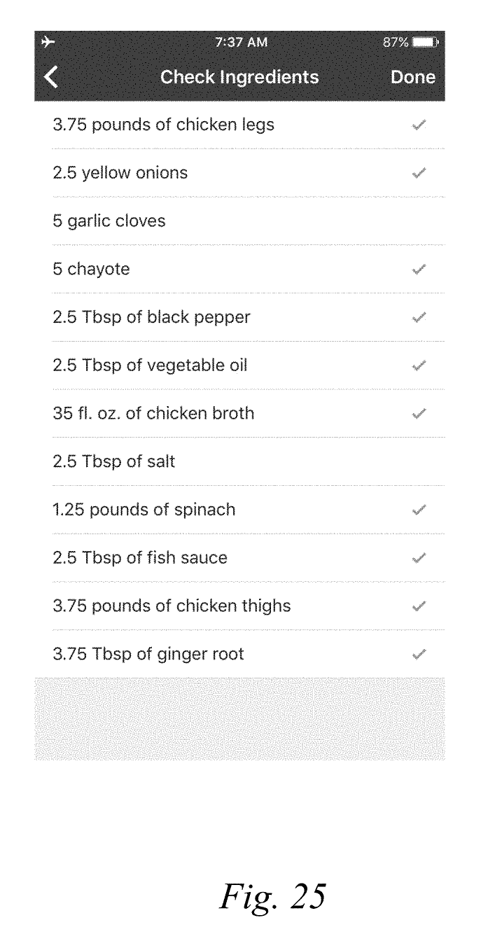

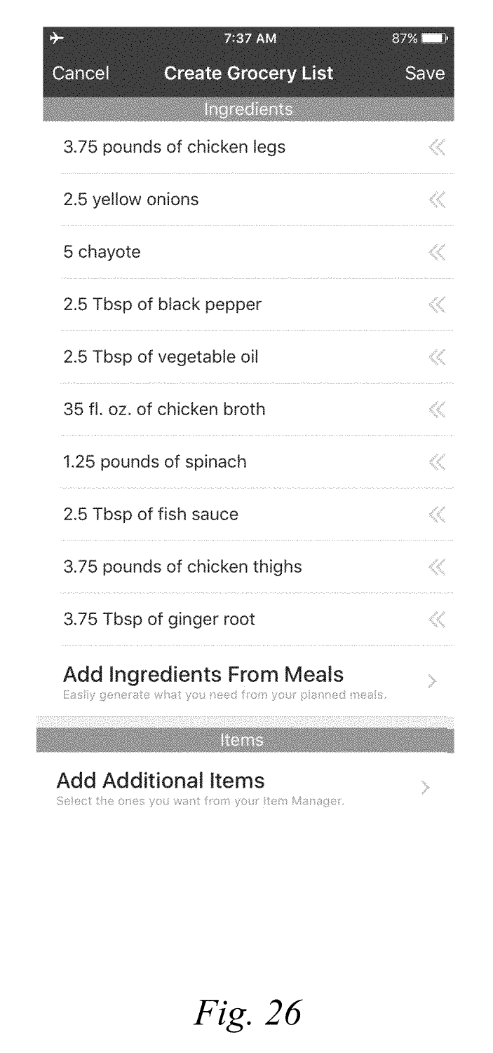

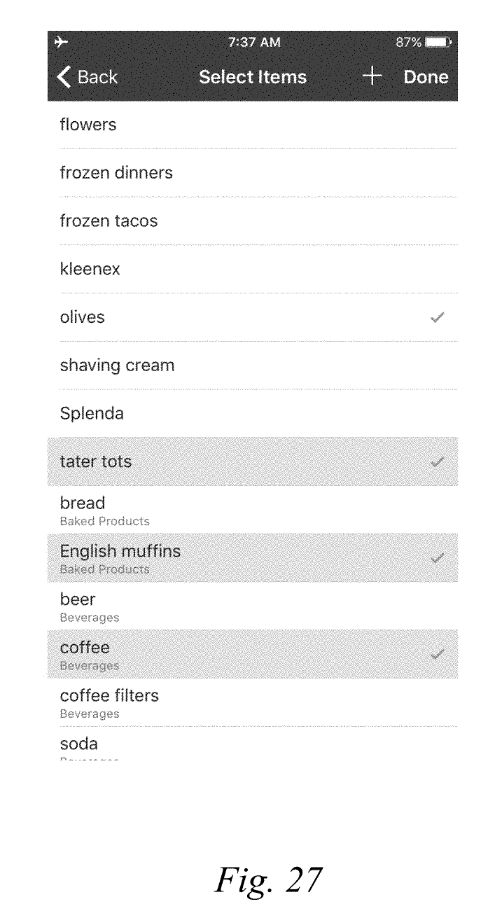

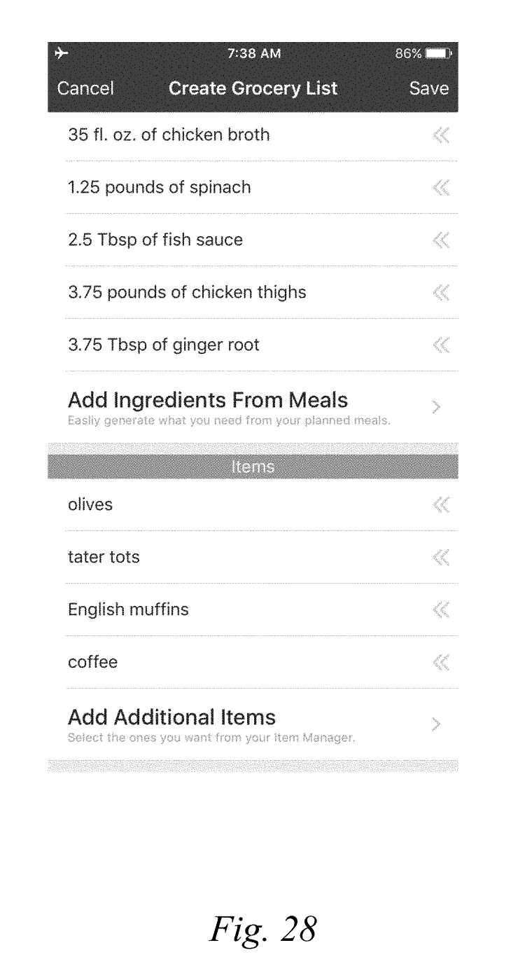

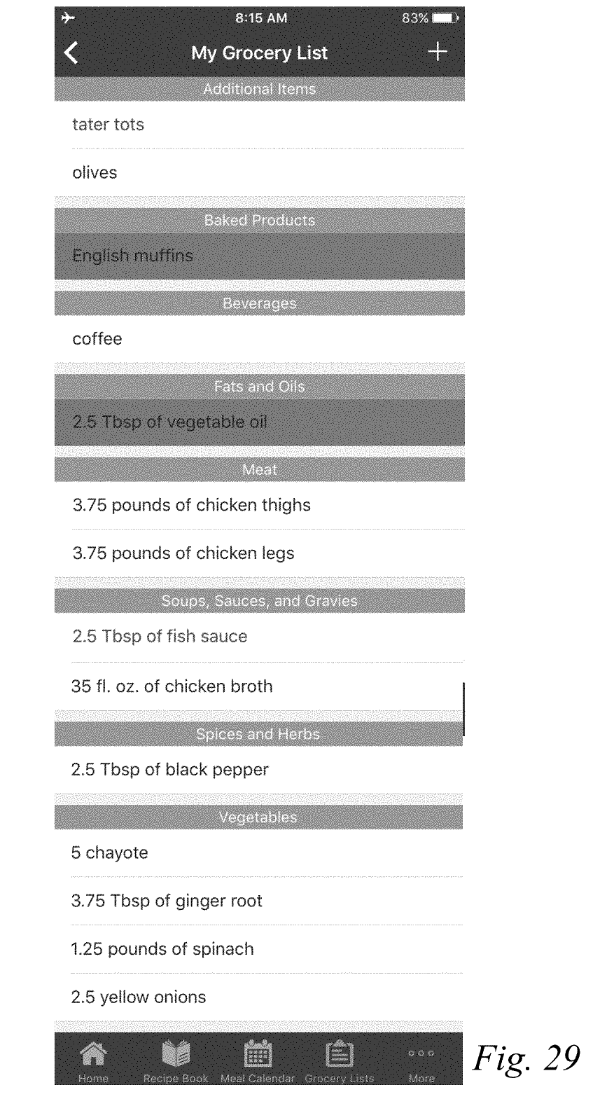

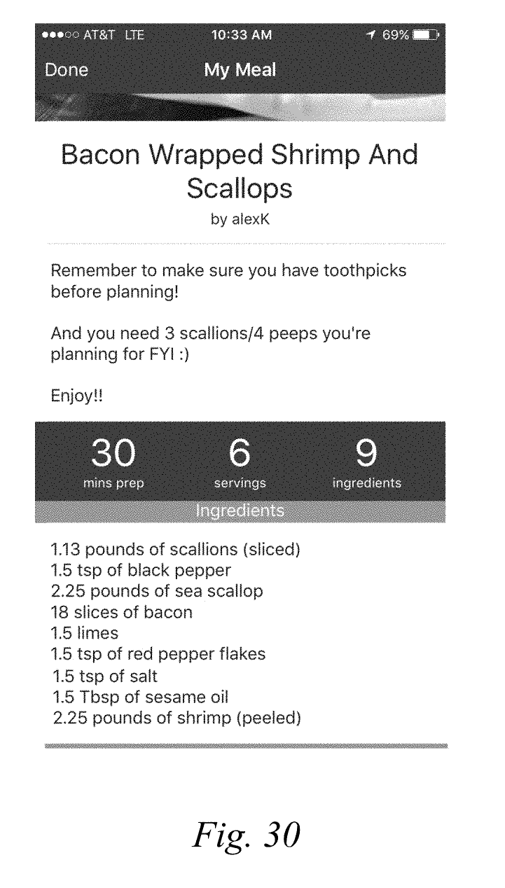

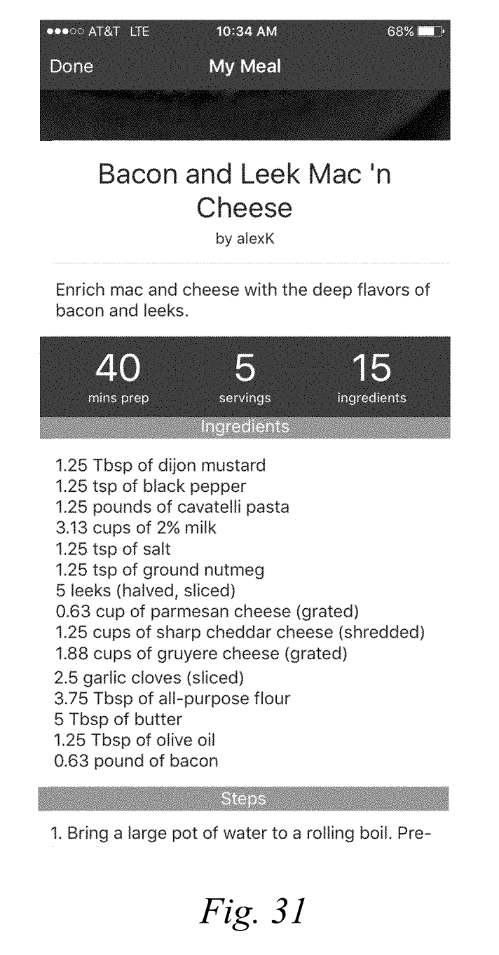

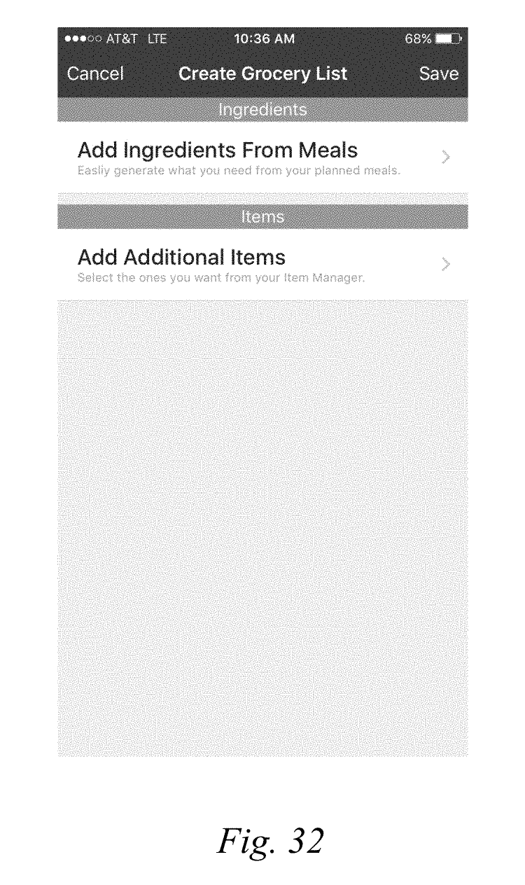

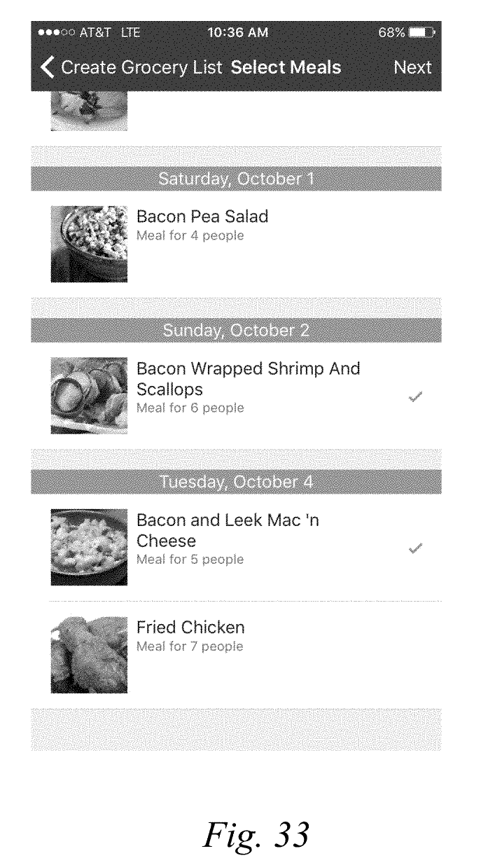

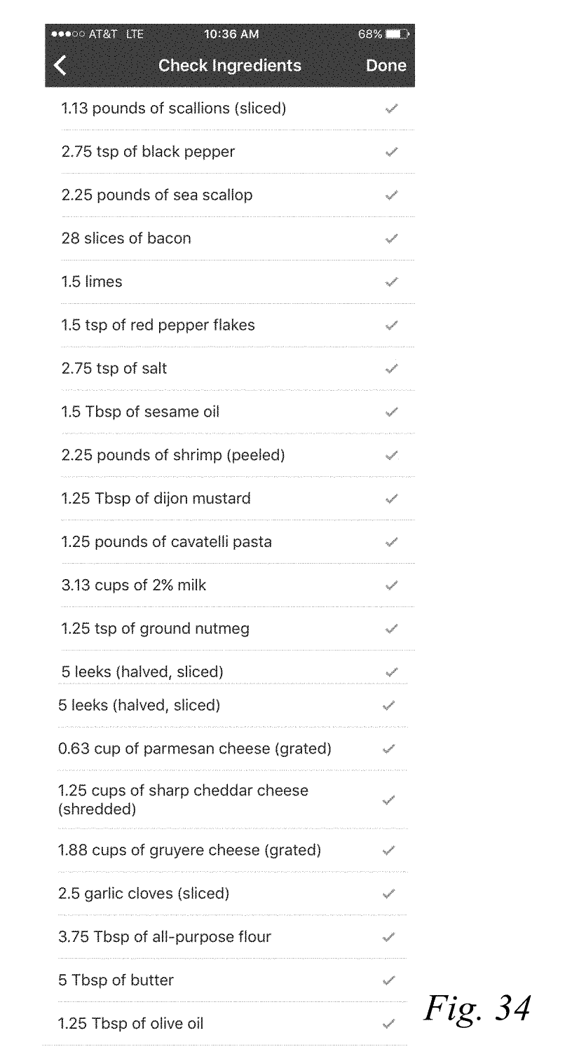

FIGS. 23-29 are interface diagrams of example user interfaces for generating a grocery list. For example, a user may plan a meal having 10 servings such that the ingredients for the meal may be scaled to accommodate 10 people (e.g., see FIGS. 20-22 for an example). The user may create a grocery list by adding ingredients from planned meals and/or may add additional items to the grocery list that the user may need (e.g., FIG. 23). When the user chooses to add ingredients from planned meals, the user may select the meals to be used to generate the grocery list (e.g., FIG. 24). For example, the user may select from the list of planned meals shown in FIG. 24 (e.g., “Chicken Tinola” and “Bacon Wrapped Shrimp and Scallops”), and the grocery list may show those ingredients in their combined amounts based on the ingredient framework (e.g., for an example of generating a grocery list with ingredients combined for multiple planned meals, see FIGS. 30-34). The ingredients may be populated in a user interface (e.g., FIG. 25) and may be the combined ingredients based on the meals that were selected. The user interface may allow a user to deselect (and/or reselect) ingredients based on what the user would like to purchase. For example, a user may deselect a particular ingredient if the user already possess the ingredient. When the user has selected and/or deselected the appropriate ingredients, a user interface may appear that shows the added ingredients and options to add additional meal ingredients and/or other items (e.g., FIG. 26). If the user chooses to add ingredients from additional meals, those ingredients may be intelligently combined with ingredients from other recipes associated with the grocery list based on the ingredient framework. If the user chooses to add additional items to the grocery list, the user may view a list of items to add (e.g., FIG. 27). This list may include items that a user has previously added and/or highlighted. Items may be added to this list by a user at any time. For example, a user may maintain a list of items that the user purchases on a regular basis. The user may also have the ability to highlight specific items as a reminder to the user to add the highlighted item to the next grocery list to be generated. In FIG. 27, any pre-added and/or pre-highlighted items may appear, and the user may select certain items to add to the grocery list, as shown by the check mark next to the item. The user may also have the option to add additional items by selecting the “+” button. Once the user has finished adding additional items, a user interface may appear that shows the added ingredients and items (e.g., FIG. 28). When the user is satisfied with the grocery list, the user may save the grocery list. The generated grocery list (e.g., FIG. 29) may be organized by ingredient group using the ingredient framework. This grocery list may be used while a user shops for groceries and allows a user to tap on an item once to indicate that the user has placed the item in their shopping cart (e.g., the darkened ingredients in FIG. 29) and/or tap on an item twice to indicate that the user could not find the item while shopping (e.g., the red ingredients (e.g., tater tots, 2.5 Tbsp of fish sauce) in FIG. 29).

In some embodiments, the grocery list creation module 210 may maintain a list of ingredients that the user has in their inventory, and that inventory list may be updated by the user. In some embodiments, the grocery list creation module 210 may be in communication with any household objects that may be part of the Internet of Things (IoT) in order to maintain an inventory of ingredients for a user. The IoT is the network of physical objects (e.g., device, vehicles, buildings, appliances, etc.) embedded with electronics, software, sensors, and network connectivity to enable these objects to collect and exchange data. The grocery list creation module 210 may access data from any suitable IoT object (e.g., a refrigerator, a freezer, a pantry, etc.) to obtain inventory information associated with ingredients and/or items that the user may have in their home, and this information may be used to generate a grocery list.

In some embodiments, the grocery list creation module 210 may display a list of the identified items and allow the user to remove certain items from the list if the user already has those ingredients in their inventory. In some embodiments, the grocery list creation module 210 may allow a user to add additional items to the grocery list that the user may wish to purchase (e.g., toilet paper, trash bags, etc.) In some embodiments, the grocery list creation module 210 may sort the list of items in an order that is based on where the items may be found in a store (e.g., based on grocery store aisles). In some embodiments, the grocery list creation module 210 may sort the list of items in an order based on when each particular item is to be used in the meal plan. For example, a meal plan that is created for a particular week (e.g., Sunday through Saturday) may include a Thursday dinner involving salmon, and the grocery list creation module 210 may sort the list of items for the meal plan based on the time the items are to be used (e.g., by moving salmon toward the middle or bottom of the list), which may indicate to the user that the items toward the end of the list may be purchased later in the week such that the ingredients used may be fresher. The user may use the created list to shop for the items in a physical grocery store. In some embodiments, the list of items may be used by a user to shop for the items in a grocery store.

In some embodiments, the grocery list creation module 210 may allow a user to provide feedback about availability of various items in a grocery store. For example, if a user is shopping in a store, the user may provide feedback about items that are on sale, items that are out of stock, items that are available, and the like.

The purchase module 212 may be a hardware-implemented module that may manage, control, and facilitate the online purchase of the ingredients in the list. The purchase may be made through the computing device 200 and/or may be made by being redirected to a particular website for ordering ingredients from a provider. In some embodiments, the purchase module 212 may allow a user to purchase the ingredients at a particular provider (e.g., based on user selection, based on user preferences, based on loyalty memberships the user has with a particular online store, etc.). The purchase module 212 may send the user's request for the ingredients to the specified provider (e.g., provider computing device 106), and the provider may fulfill and/or deliver the order. The user may have the option to pick up the fulfilled order in a physical store of the provider (e.g., by entering the store and picking up the ingredients, by picking up the ingredients via a drive-through window, etc.) or have the fulfilled order delivered to the user. In some embodiments, the order may be delivered to the user by the provider of the ingredients or by a third-party delivery service (e.g., a courier service, a transportation service, etc.). In some embodiments, the user's request for the ingredients may be sent to both a provider associated with supplying the ingredients and a provider associated with a transportation service, such as a ride-sharing service, such that the provider associated with supplying the ingredients may fulfill the order and the provider associated with the transportation service may deliver the fulfilled order. In some embodiments, an order may be fulfilled and/or delivered by the food management system. The purchase module 212 may notify the user once the order is fulfilled and/or delivered (e.g., via text, phone call, a notification in an application, etc.). In some embodiments, a user may set rules relating to when various ingredients are to be delivered. For example, a user may specify that salmon is to be delivered a particular number of days before the salmon is to be prepared for a particular meal, or that grocery items are to be ordered periodically (e.g., every 3 days). In some embodiments, the food management system may process the order transaction on behalf of a third party, and the food management system may subsequently process the transaction with the third party. In some embodiments, the food management system may fulfill the grocery order (e.g., supply ingredients, deliver ingredients, etc.).

In some embodiments, the purchase module 212 may optimize a user's order request based on any suitable factors, such as pricing of various ingredients offered by different providers, location of various providers, based on when the recipes are to be prepared according to the meal plan, timing of delivery, ratings of providers, user preferences, and the like. In some embodiments, the purchase module 212 may order ingredients from one or more providers for a given user and/or meal plan. In some embodiments, the purchase module 212 may order ingredients requested by one or more users such that the ingredients may be purchased and/or delivered in bulk for a better price. In some embodiments, the purchase module 212 may combine orders for users and give each user a discount on the order and/or delivery price.

The recipe preparation module 214 may be a hardware-implemented module that may manage, control, facilitate, and provide information associated with preparing recipes. The recipe preparation module 214 may provide information to users about how to prepare a particular recipe (e.g., written instructions, visual instructions, video, audio, hologram, wearable device, etc.). In some embodiments, the information provided may be created and/or performed by the author of the particular recipe to be prepared. In some embodiments, the recipe preparation module 214 may provide information that may encourage a user to continue with their specified meal plan. For example, if a user has not accessed their account for a particular amount of time, the recipe preparation module 214 may send information to the user encouraging the user to continue their meal plan. In some embodiments, the recipe preparation module 214 may send a user reminders relating to preparing a particular meal, such as a reminder to defrost meat to be used in a recipe of the meal. In some embodiments, the recipe preparation module 214 may send information associated with a particular meal and/or recipe at any suitable time (e.g., before, during, or after preparation of the meal). For example, if a user is to prepare a meal with salmon, the recipe preparation module 214 may inform the user that salmon is good source for omega-3 fatty acids that help reduce high blood pressure. In some embodiments, the information sent may be rated by the user. In some embodiments, the recipe preparation module 214 may send the user ideas about what the user can do with the leftovers (e.g., turn corned beef dinner into a corned beef hash for breakfast the next day).

In some examples, the recipe preparation module 214 may provide information associated with how to prepare a particular meal that has been planned. For example, a meal (e.g., dinner) may be a multi-recipe meal, where the meal may be associated with more than one recipe (e.g., a main dish and a side dish). In this case, the recipe preparation module 214 may display information about the recipes in the meal in a manner that allows a user to easily access instructions for each of those recipes. For example, when a user is ready to begin preparing a meal, the recipe preparation module 214 may provide and/or display instructions for each recipe in a meal, where the user may easily switch back and forth between each recipe's instructions (e.g., by swiping back and forth between screens on a touch user interface). In some examples, switching between instructions for each recipe in a meal may be associated with a particular animation that may occur as a user switches from a first set of instructions for a recipe in a meal to another set of instructions for another recipe in the meal. In some examples, the recipe preparation module 214 may intelligently combine instructions for recipes in a multi-recipe meal in any suitable manner. For example, the recipe preparation module 214 may intelligently combine instructions for recipes in a multi-recipe meal such that the steps of each recipe may be performed in an efficient order (e.g., while food associated with a first recipe in a meal is cooking in the oven, the recipe preparation module 214 may provide instructions for a second recipe in the meal such that the second recipe in the meal may be efficiently prepared while the food associated with the first recipe cooks in the oven). The instructions may be combined in any suitable manner. In some examples, a user creating a recipe may specify a time associated with each step of the recipe (e.g., a length of time for each step to be performed, a length of time between the beginning of the step and the time at which the recipe will be prepared in completion, etc.), and the specified time may be used to intelligently organize instructions for a multi-recipe meal.

The user socialization module 216 may be a hardware-implemented module that may manage, control, and facilitate social features associated with the food management system. The user socialization module 216 may allow a user to create a personalized profile page, connect with other users, view profile pages of other users, share meal plans, post comments (e.g., tips for cooking healthy), share pictures and/or videos, and the like. For example, when a recipe and/or a meal is prepared by a user, the user may post pictures of their recipe and/or meal to the user's profile page, and other users may leave comments and/or ratings associated with the picture. The user socialization module 2016 may allow a user to rate various recipes they have prepared, share experiences with other users, leave comments about various recipes, share recipes, access a list of favorite recipes of other users, access other users' meal plans, share user-generated content (e.g., recipes, videos, etc.), create group shopping lists associated with a group of users (e.g., group list for users living in the same neighborhood to allow for bulk shopping), connect and communicate with various users and/or entities (e.g., an entity associated with a particular diet and/or meal plan), create groups of users (e.g., group of users with access to a group discussion board), and the like. In some embodiments, the user socialization module 216 may provide social features that allow users to compete with one another based on any suitable criteria (e.g., best presentation of a dish).

In some embodiments, the user socialization module 216 may provide a data feed to users that may allow users to receive updated data from various data sources. The data feed may be presented to users in any suitable manner, such as a web feed (e.g., a news feed), and a rich site summary (RSS) feed, and the like. The data feed may provide any suitable data to users, such as notifications about various events, the activity of other users within and/or outside of a user's social network (e.g., pictures posted by other users, messages from other users, new user connection requests, etc.), and the like.

In some embodiments, the user socialization module may allow users to connect with other users within a particular vicinity (e.g., a user in the same physical neighborhood of a city) for various purposes. For example, users may communicate with other users nearby such that users may connect with one another physically to have meals together, share leftovers, buy and/or sell any meals prepared, and the like.

The content management module 218 may be a hardware-implemented module that may store, manage, and provide content available to users, such as recipes, meal plans, videos, audio recordings, images, virtual reality, and the like. In some embodiments, the content management module 218 may allow users to create and manage user-generated content. For example, the content management module 218 may allow a user to create a recipe and/or a meal plan that may include pictures of a prepared recipe, an ingredients list for a recipe, instructions for preparing a recipe, videos, and the like. In some embodiments, the content management module 218 may provide a recipe template that may allow a user to create a recipe by populating the recipe template with various information associated with a recipe, such as pictures of the prepare recipe, ingredients for making the recipe, kitchen tools used to make the recipe, instructions for preparing the recipe, a video providing instructions about preparing the recipe, and the like. In some embodiments, the content management module 218 may provide a meal plan template that may allow a user to create a meal plan. For example, the content management module 218 may provide a meal plan template that may allow a user to drag and drop various recipes into a calendar view associated with a meal plan.

In some embodiments, the content management module 218 may provide video editing capabilities that a user may use to edit a video of the user giving a demonstration of preparing a particular recipe. In some embodiments, the content management module 218 may allow a user to create and provide a video having any suitable content. For example, a user may create and provide an instructional video about cooking.

In some embodiments, the content management module 218 may provide suggestions to users creating content (e.g., a recipe, a meal plan, a video, etc.). The suggestions may be any suitable suggestions for any suitable purpose, such as a suggestion for formatting content, a suggestion about the type of content to include, and the like.

The marketing management module 220 may be a hardware-implemented module that may manage and control any marketing aspects associated with the food management system, including marketing associated with users, providers, and/or the food management system itself. For example, the marketing management module 220 may promote various grocery item brands, users (e.g., content creators), providers (e.g., grocery stores, restaurants, delivery service providers, etc.) using any marketing techniques (e.g., direct sales techniques, branded marketing, targeted marketing, etc.). In some embodiments, the marketing management module 220 may promote various entities associated with the food management system based on payment from those entities, based on a status of those entities (e.g., promoting highly-rated content creators, promoting entities that are new to the food management system, etc.), and the like.

The provider information module 222 may be a hardware-implemented module that may manage, control, access, and store information associated with providers (e.g., suppliers, transportation service providers, etc.). For example, the provider information module 222 may manage information associated with grocery stores, such as locations of various grocery stores, inventory available at various grocery stores, prices for various items in each grocery store, sales and/or promotions at various grocery stores, and the like. In other examples, the provider information module 222 may manage information associated with transportation service providers, such as the locations of various transportation service providers, prices, availability, ratings, and the like. The information may be visible to users and/or providers in any suitable manner. For example, a user may view a geographical map showing various grocery stores, and the user may click on a grocery store displayed on the map to view additional data about that particular grocery store (e.g., inventory, prices for various items, sales, etc.). The information managed by provider information module 222 may be accessed in any suitable manner. For example, a user may provide the information to the provider information module 222 via a computing device of the user as the user learns the information (e.g., crowd-sourced information for users in grocery stores), the providers may provide the information to the provider information module 222, and the like. In some embodiments, provider information module 222 may notify users about items that may be out of stock in certain locations. In some embodiments, provider information module 222 may access a grocery list of a user and display grocery stores based on the grocery list. For example, the provider information module 222 may display grocery stores that carry all or most of the items on a user's grocery list. In some embodiments, the provider information module 222 may display the cost of purchasing a set of ingredients at various grocery stores such that a user may compare prices.

The user communication module 224 may be a hardware-implemented module that may manage and control user communication in any suitable form. For example, the user communication module 224 may provide chat and/or messaging functionality such that users and/or providers may communicate with one another. In some embodiments, the user communication module 224 may allow users to make requests for various recipes and/or meal plans in any suitable manner. For example, the user communication module 224 may provide a forum and/or a digital bulletin board that may allow a user to request a particular meal plan that the user wishes to have fulfilled based on user-specified criteria, and users who create content may sort through, view, and fulfill these requests accordingly. For example, User A may request a meal plan that is suitable for a busy couple between the ages of 31-35 who live in San Francisco, wish to eat meals that are no more than 500 calories, and wish to pay no more than $10 per month for the meal plan. Various users may view this request, and any particular user (e.g., User B) may fulfill the request by creating a meal plan designed based on the criteria specified by User A. In some embodiments, users may be notified when their requests have been fulfilled by another user.

The health diary module 226 may be a hardware-implemented module that may provide functionality associated with an online health diary or journal for a user of the food management system. The health diary module 226 may allow a user to access and maintain a health diary such that the user may log and/or monitor various aspects of the user's health, such as the user's food intake, calories, fat, carbohydrates, nutrients, exercise, activity level, weight, sleep, and the like. In some embodiments, the health diary module 226 may automatically update a user's health diary based on meal plans associated with the user. In some embodiments, the health diary module 226 may synchronize and access information associated with a wearable device of a user in order to log any health measurements tracked by the wearable device (e.g., heart rate, steps taken, stairs climbed, distance traveled, calories burned etc.).

In some examples, the health diary module 226 may be in communication with a biometric device of a user, where the biometric device may measure and/or monitor any suitable biometrics of a user, such as calories consumed, type of calories consumed (e.g., fat, protein, carbohydrate, etc.), heart rate, activity, and the like. In some examples, the health diary module 226 may automatically synchronize with a biometric device of a user to input any suitable biometrics of the user. In some examples, the biometric information may be used to automatically adjust serving sizes for meals based on biometric data. In some examples, the biometric information may be used to automatically adjust any suitable data associated with recipes and/or meal plans.

The customer relationship management module 228 may be a hardware-implemented module that may manage, control, access, and provide information and/or features associated with managing clients who are associated with the food management system. The customer relationship management module 228 may provide an interface between various users who may be associated based on a client relationship. For example, health entities such as health coaches, meal planners, nutritionists, medical specialists, personal trainers, life coaches, and the like may have clients that may be managed using features provided by the customer relationship management module 228. For example, the customer relationship management module 228 may provide features that allow health entities to market themselves and/or be searched and found in any suitable manner (e.g., through client ratings, promotional materials, etc.). The customer relationship management module 228 may provide features that allow health entities to monitor their clients' health, such as monitoring food intake, fitness level and/or activities, clients' health diary, weight, and the like. In some embodiments, the customer relationship management module 228 may provide a health dashboard associated with a client that a health entity may view for each of the entity's clients, where the health dashboard may display various figures, graphs, tables, statistics, events, and/or activities related to the corresponding client's health. The customer relationship management module 228 may provide various analytical tools to health entities to aid in client management. For example, the customer relationship management module 228 may provide a health entity with analytical marketing tools that provide feedback about the health entity's marketing impact on potential and existing clients. The customer relationship management module 228 may provide analytical tools that may help a health entity succeed in and/or grow their business, such as analytics about how long the health entity is able to maintain each client. The customer relationship management module 228 may provide payment features to manage payment for services between a health entity and a client of the health entity.

The customer relationship management module 228 may be a scheduling tool that may automatically generate client communications for a health entity. For example, a health entity may specify preferences associated with sending communications to clients, and the customer relationship management module 228 may automatically generate communications based on those preferences (e.g., automatically send reminders to clients a day before a scheduled phone call, automatically send reminders to clients if they have not yet performed a certain specified action, etc.). These communications may be any suitable communication that may be sent in any suitable manner (e.g., email, text message, phone call, email, communication via the food management system, etc.). In some embodiments, the customer relationship management module 228 may have machine-learning capabilities that may be used for automatic communication generation. For example, the customer relationship management module 228 may learn that a health entity's client is more responsive to communications received in the morning and may adjust the timing of communications accordingly.

In some embodiments, the customer relationship management module 228 may manage information associated with a health entity's clients, such as client contact information, meetings scheduled with clients, client preferences and/or goals, and the like. In some embodiments, the customer relationship management module 228 may use a health entity's client information to intelligently provide reminders to the health entity about various client activity (e.g., remind health entity to communicate with a client after a particular amount of time has elapse since the last communication).

In some embodiments, the computing device 200 may allow a user to scan barcodes and/or take pictures of items to obtain any suitable information relating to the item, such as recipes, nutrition facts, prices, the weight and/or volume of at least a portion and/or unit of the item (e.g., the weight of one cracker), and the like. For example, a user may scan a barcode of a particular package to import the nutrition facts associated with the packaged food. In another example, a user may scan barcodes of ingredients the user may possess, and the information obtained from scanning the barcodes may be used to manage an inventory list associated with the user.

In some embodiments, the computing device 200 may gamify any features associated with the food management system. For example, recipes may be associated with a difficulty rating, and a user may receive an acknowledgement for completing a recipe for each difficulty level. In some embodiments, the computing device 200 may reward a user for achieving any suitable goal and/or task, such as user-specified goals, various diet goals, trying a particular dish and/or a particular number of dishes, being a well-traveled cook, inviting friends to join the food management system, and the like. In some embodiments, the computing device 200 may allow users to compete with each other in various ways (e.g., based on cooking meals, taking pictures of meals cooked, etc.). In some embodiments, the computing device 200 may allow users to earn badges, increase levels of difficulty in cooking, and the like.

In some embodiments, the computing device 200 may create and manage any suitable calendars and/or schedules associated with a group of users (e.g., calendars provided by the computing device 200, third-party calendars synchronized with the computing device 200, etc.). For example, an account may be associated with a household having any number of members, and the computing device 200 may manage calendars for each member. The calendar information may be used to help create meal plans based on which members will be eating which meals, when meals are to be eaten based on the household members' schedules, and the like. In some embodiments, the computing device 200 may manage any suitable items associated with a household, such as chores assigned to various household members, household finances, and the like. In some embodiments, a user with an account associated with the food management system may associate their account with another user's account such that various features and/or information may be shared between the users (e.g., a shared calendar, a shared meal plan, etc.). For example, this may allow users to remotely plan meals together. In some embodiments, users with synchronized accounts may each vote for particular meals to be prepared as part of a shared meal plan.

In some embodiments, the computing device 200 may provide an API that may allow access to various features and/or data available on the food management system. In some embodiments, the computing device 200 may provide an API to grocery stores and/or other item fulfillment entities, where the API may be used by entities to provide any suitable data associated with the items provided by the entities (e.g., prices, availability of items, discounts, sales, delivery options, store hours, operational information, etc.). The data associated with the items may be received and used by the computing device 200 to provide associated information to users, such as shopping and/or recipe recommendations. As used herein, the term recommendation includes any suitable data provided and/or surfaced to a user, such as a suggestion, option, tip, proposal, guidance, direction, and the like. For example, the data received via the API may be used to provide options of grocery stores at which a user may shop for their items, recommendations for recipes that may be prepared based on items available at a particular grocery store, and the like.

In some examples, the computing device 200 may manage a database of products available for purchase at a store. For example, the computing device 200 may manage a database of UPCs, where each UPC is associated with any suitable information about the product, such as a weight and/or volume associated with the UPC, a serving size, brand information associated with the UPC, a number of items associated with the UPC, a description of the product, information about stores that carry the product, number of UPCs per store, and the like. These UPCs may also be associated with any ingredient entry in the ingredient database, and/or each ingredient entry in the ingredient database may be associated with any number of related UPCs. This may help facilitate automatic identification, purchase, and delivery of products on a grocery list.

In some examples, the computing device 200 may manage a database of grocery stores and information associated with each grocery store. For example, the computing device 200 may manage a database of grocery stores, where each grocery store is associated with any suitable information about the grocery store, such as availability of products (e.g., identifiable by UPCs), location, delivery services, coupons and/or promotions, real-time pricing, and the like. This may help facilitate purchase and delivery of groceries.

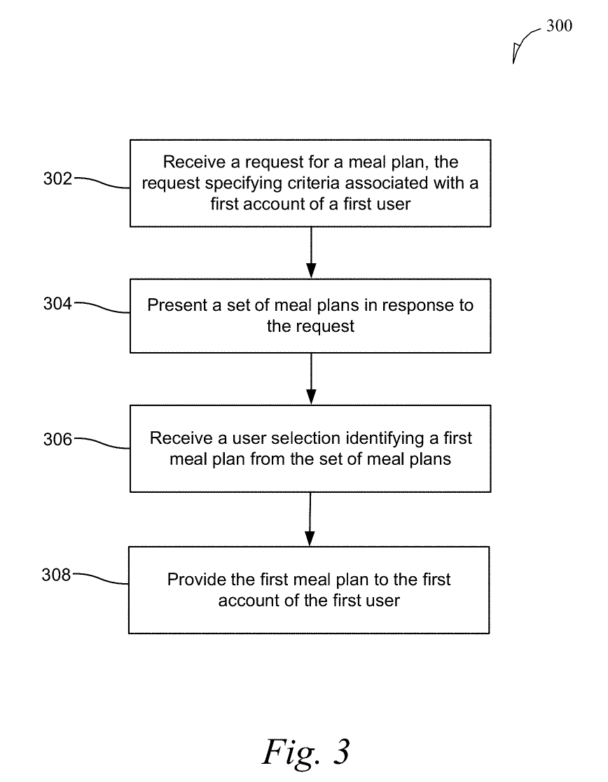

FIG. 3 is a flow chart showing an example method 300 for food management, in accordance with an example embodiment. The method 300 may be performed by the computing device 200 shown in FIG. 2 and provides an example of providing a meal plan to a user.

In operation 302, the meal plan management module 206 may receive a request for a meal plan, where the request specifies criteria associated with a first account of a first user. For example, a user that has an account with the food management system may submit a request specifying criteria associated with the type of meal plan the user would like to receive (e.g., a vegan meal plan with no broccoli).

In operation 304, the meal plan management module 206 may present a set of meal plans in response to the request. Each meal plan in the set of meal plans may be associated with a particular user and may fulfill at least a portion of the criteria specified. For example, the meal plan management module 206 may return various meal plans that fulfill at least some of the criteria specified in the user request. Each of the meal plans that are presented may be associated with a user account of a user who created the respective meal plan.

In operation 306, the meal plan management module 206 may receive a user selection identifying a first meal plan from the set of meal plans. The first meal plan may be associated with a second account of a second user and may specify one or more recipes. For example, the first user may select a particular meal plan that the user wishes to receive, and that meal plan may be associated with a second account of a user who created the selected meal plan.

In operation 308, the meal plan management module 206 may provide the first meal plan to the first account of the first user. The first meal plan may be provided to the account of the first user such that the first user may begin to use the meal plan selected.

In some examples, a method performed by the server 102, the user computing device 104, and/or a provider computing device 106 may include receiving an indication to generate a grocery list based on a first recipe and a second recipe, the first recipe including a first amount of an ingredient, the second recipe including a second amount of the ingredient, the first amount being specified using a first unit of measure and the second amount being specified using a second unit of measure; accessing an ingredient database including accessing a conversion between units of measure for the ingredient; calculating a combined amount of the ingredient based on the conversion, the first amount, and the second amount; and generating the grocery list, wherein the grocery list specifies the combined amount of the ingredient.

In some examples, a method performed by the server 102, the user computing device 104, and/or a provider computing device 106 may include providing a first set of instructions associated with a first recipe in a meal; receiving a user input associated with a request to view a second recipe in the meal, the user input being received while the first set of instructions is being provided; and providing a second set of instructions associated with the second recipe.

In some examples, a method performed by the server 102, the user computing device 104, and/or a provider computing device 106 may include managing a meal plan associated with a user; accessing biometric information associated with the user, the biometric information being accessed from a biometric device associated with the user; and automatically adjusting the meal plan based on the biometric information.

In some examples, a method performed by the server 102, the user computing device 104, and/or a provider computing device 106 may include accessing a meal plan associated with a user; identifying ingredients associated with the meal plan; accessing inventory information from an Internet of Things object; and generating a grocery list based on the ingredients and the inventory information.

In some examples, a method performed by the server 102, the user computing device 104, and/or a provider computing device 106 may include receiving information associated with items provided by a provider, the information being received via an application programming interface; and providing a recommendation to a user based on the information, the recommendation relating to a recipe.

In some examples, a method performed by the server 102, the user computing device 104, and/or a provider computing device 106 may include receiving data associated with a modification of an existing recipe, the modification specifying attribute data and relativity data; storing a subsequent version of the existing recipe based on the modification including storing the attribute data and the relativity data with the subsequent version; and providing the existing recipe and a recommendation associated with the subsequent version of the existing recipe, the recommendation including the attribute data and the relativity data

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

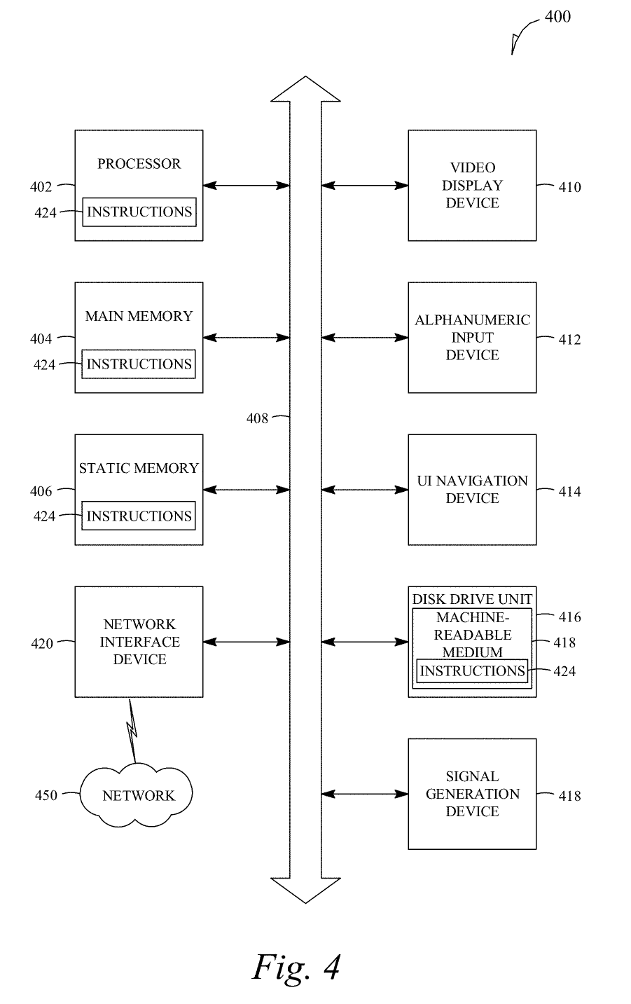

FIG. 4 is a block diagram of a machine in the example form of a computer system 400 within which instructions, for causing the machine to perform any one or more of the methodologies discussed herein, may be executed. In alternative embodiments, the machine operates as a standalone device or may be connected (e.g., networked) to other machines. For example, the machine may be connected to other machines via network 450, which may be any suitable network. In various embodiments, one or more portions of the network 450 may include an ad hoc network, an intranet, an extranet, a VPN, a LAN, a WLAN, a WAN, a WWAN, a MAN, a portion of the Internet, a portion of the PSTN, a cellular telephone network, or any other type of network, or a combination of two or more such networks. In a networked deployment, the machine may operate in the capacity of a server or a client machine in server-client network environment, or as a peer machine in a peer-to-peer (or distributed) network environment. The machine may be a PC, a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 400 includes a processor 402 (e.g., a central processing unit (CPU), a graphics processing unit (GPU) or both), a main memory 404, and a static memory 406, which communicate with each other via a bus 408. Computer system 400 may further include a video display device 410 (e.g., a liquid crystal display (LCD) or a cathode ray tube (CRT)). Computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

Disk drive unit 416 includes a machine-readable medium 422 on which is stored one or more sets of instructions and data structures (e.g., software) 424 embodying or utilized by any one or more of the methodologies or functions described herein. Instructions 424 may also reside, completely or at least partially, within main memory 404, within static memory 406, and/or within processor 402 during execution thereof by computer system 400, main memory 404 and processor 402 also constituting machine-readable media.

While machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 424 may further be transmitted or received over a communications network 426 using a transmission medium. Instructions 424 may be transmitted using network interface device 420 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

While the embodiment(s) is (are) described with reference to various implementations and exploitations, it will be understood that these embodiments are illustrative and that the scope of the embodiment(s) is not limited to them. Many variations, modifications, additions, and improvements are possible.

Plural instances may be provided for components, operations, or structures described herein as a single instance. Finally, boundaries between various components, operations, and structures are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method, comprising:
identifying a first amount of a first ingredient and a second amount of a second ingredient from at least one user selection within a graphical user interface;
accessing an ingredient database specifying ingredients and a set of characteristics defining each ingredient, wherein at least a portion of the ingredients are each defined by a density value of the respective ingredient;
identifying, within the ingredient database, a first characteristic associated with the first ingredient and a second characteristic associated with the second ingredient; and
automatically calculating a result in response to the at least one user selection within the graphical user interface, wherein the result is calculated based on the first characteristic and the second characteristic.

2. The method of claim 1, wherein the at least one user selection includes an indication to generate a grocery list based on a first recipe and a second recipe, wherein the first recipe includes the first amount of the first ingredient and the second recipe includes the second amount of the second ingredient, wherein the first ingredient is a same ingredient as the second ingredient, wherein the first amount is specified using a first unit of measure and the second amount is specified using a second unit of measure, and wherein the result is a combined amount of the first ingredient and the second ingredient.

3. The method of claim 1, wherein the at least one user selection includes an indication to generate a grocery list based on a first recipe including the first amount of the first ingredient and a second recipe including the second amount of the second ingredient, wherein the result is the grocery list, and wherein the method further comprises:
sending, to a grocery delivery entity, a request to deliver items on the grocery list.

4. The method of claim 1, wherein at least one user selection includes an indication to generate a grocery list based on a first recipe including the first amount of the first ingredient and a second recipe including the second amount of the second ingredient, wherein the result is the grocery list, and wherein the result is calculated using inventory information.

5. The method of claim 1, wherein the first characteristic and the second characteristic is a nutritional characteristic and wherein the result is a nutritional value.

6. The method of claim 3, wherein the nutritional characteristic relates to fat, protein, carbohydrates, calories, a particular vitamin, or a particular nutrient.

7. The method of claim 3, further comprising:
providing the result to a health journal of a user.

8. The method of claim 1, wherein the first characteristic is a weight of an item of the first ingredient.

9. The method of claim 1, wherein the first characteristic is a volume of an item of the first ingredient.

10. The method of claim 1, further comprising:
causing display of the result in response to the at least one user selection within the graphical user interface.

11. The method of claim 1, wherein the first characteristic is a qualifier of the first ingredient and wherein the result includes a manner of presenting a description of the first ingredient using the qualifier.

12. A device, comprising:
a processor; and
a non-transitory machine-readable storage medium in communication with the processor, the non-transitory machine-readable storage medium storing instructions which, when executed by the processor, cause the processor to perform operations, comprising:
identifying a first amount of a first ingredient and a second amount of a second ingredient from at least one user selection within a graphical user interface;
accessing an ingredient database specifying ingredients and a set of characteristics defining each ingredient, wherein at least a portion of the ingredients are each defined by a density value of the respective ingredient;
identifying, within the ingredient database, a first characteristic associated with the first ingredient and a second characteristic associated with the second ingredient; and
automatically calculating a result in response to the at least one user selection within the graphical user interface, wherein the result is calculated based on the first characteristic and the second characteristic.

13. The device of claim 12, wherein the at least one user selection includes an indication to generate a grocery list based on a first recipe and a second recipe, wherein the first recipe includes the first amount of the first ingredient and the second recipe includes the second amount of the second ingredient, wherein the first ingredient is a same ingredient as the second ingredient, wherein the first amount is specified using a first unit of measure and the second amount is specified using a second unit of measure, and wherein the result is a combined amount of the first ingredient and the second ingredient.

14. The device of claim 12, wherein the first characteristic and the second characteristic is a nutritional characteristic and wherein the result is a nutritional value.

15. The device of claim 14, wherein the nutritional characteristic relates to fat, protein, carbohydrates, calories, a particular vitamin, or a particular nutrient.

16. The device of claim 12, wherein the first characteristic is a weight or a volume of an item of the first ingredient.

17. A non-transitory machine-readable storage medium storing instructions which, when executed by one or more processors, cause the one or more processors to perform operations, comprising:
identifying a first amount of a first ingredient and a second amount of a second ingredient from at least one user selection within a graphical user interface;
accessing an ingredient database specifying ingredients and a set of characteristics defining each ingredient, wherein at least a portion of the ingredients are each defined by a density value of the respective ingredient;
identifying, within the ingredient database, a first characteristic associated with the first ingredient and a second characteristic associated with the second ingredient; and
automatically calculating a result in response to the at least one user selection within the graphical user interface, wherein the result is calculated based on the first characteristic and the second characteristic.

18. The non-transitory machine-readable storage medium of claim 17, wherein the first characteristic and the second characteristic is a nutritional characteristic and wherein the result is a nutritional value.

19. The non-transitory machine-readable storage medium of claim 17, wherein the nutritional characteristic relates to fat, protein, carbohydrates, calories, a particular vitamin, or a particular nutrient.

20. The non-transitory machine-readable storage medium of claim 17, wherein the first characteristic is a weight or a volume of an item of the first ingredient.
